(19) United States
(12) Patent Application Publication
(10) Pub. No.: US 2016/0177184 A1
(43) Pub. Date: Jun. 23, 2016

(54) Bio-Oils and Methods of Producing Bio-Oils from Guayule Bagasse and/or Leaves

(71) Applicant: The United States of America, as Represented by the Secretary of Agriculture, Washington, DC (US)

(72) Inventors: Akwasi A. Boateng, Royersford, PA (US); Charles A. Mullen, Lansdale, PA (US); Yaseen M. Elkasabi, Wyncote, PA (US)

(21) Appl. No.: 14/574,823

(22) Filed: Dec. 18, 2014

(51) Int. Cl. C10G 1/00; C10B 53/02; C10L 1/02; C01B 5/00; C10G 3/00; C10L 1/04

(52) U.S. Cl. CPC C10G 1/002; C10G 3/50; C10L 1/04; C10L 1/02; C01B 5/00; C10B 53/02; C10L 2200/0469; C10L 2270/023; C10L 2270/026; C10L 2270/04; C10L 2290/02; C10L 2290/543

(57) ABSTRACT

Methods for producing bio-oil from a feedstock (e.g., guayule bagasse and/or guayule leaves), involving (1) pyrolyzing the feedstock in an inert atmosphere in a reactor to produce bio-oil, bio-char and non-condensable gases; (2) recycling about 10 to about 99% of the non-condensable gases to the reactor to produce deoxygenated bio-oil; wherein the method is conducted in the absence of oxygen and wherein said method does not utilize externally added catalysts. Also disclosed are bio-oils produced from such methods. Additionally, the methods further involving (a) first distilling the bio-oil to produce distillates and then reacting the distillates in a hydrodeoxygenation reactor in a chemically reductive atmosphere (e.g., hydrogen environment to produce hydrocarbons, water, and non-condensable gases or (b) reacting the bio-oil after centrifugation in a hydrodeoxygenation reactor in a chemically reductive atmosphere (e.g., hydrogen environment to produce hydrocarbons, water and non-condensable gases, and then distilling to produce distilled water and distilled hydrocarbons; and distilled hydrocarbons produced from such methods.

### BACKGROUND OF THE INVENTION

Methods for producing bio-oil from a feedstock (e.g., guayule bagasse and/or guayule leaves), involving (1) pyrolyzing the feedstock in an inert atmosphere in a reactor to produce bio-oil, bio-char and non-condensable gases; (2) recycling about 10 to about 99% of the non-condensable gases to the reactor to produce deoxygenated bio-oil; wherein the method is conducted in the absence of oxygen and wherein the method does not utilize externally added catalysts. Also disclosed are bio-oils produced from such methods. Additionally, the methods further involving (a) first distilling the bio-oil to produce distillates and then reacting the distillates in a hydrodeoxygenation reactor in a chemically reductive atmosphere (e.g., hydrogen environment) to produce hydrocarbons, water, and non-condensable gases or (b) reacting the bio-oil after centrifugation in a hydrodeoxygenation reactor in a chemically reductive atmosphere (e.g., hydrogen environment) to produce hydrocarbons, water and non-condensable gases, and then distilling to produce distilled water and distilled hydrocarbons; and distilled hydrocarbons produced from such methods.

Guayule (Parthenium argentatum), a hardwood desert shrub which grows mainly in the southwest United States and in Mexico, has been known to be a potential domestic source of rubber and organic chemicals since it biosynthesizes high quality natural rubber (Ray, D. T., Guayule: A source of natural rubber, pages 338-343, In: J. Janick and J. E. Simon (eds.), New Crops, 1993, Wiley, New York). It has been reported that guayule became a replacement for Hevea tree-produced latex during World War 2 when Malaysian latex supply to the US was cut off only to be discontinued after the war due to cheaper imports of tree-derived latex (Nakayama, F. S., Ind. Crop Prod., 22: 3-13 (2005)). However, recent commercial success in producing guayule latex primarily has been attributed to a recent discovery that guayule latex is safe for people with Type I latex allergy which has resulted in guayule's re-introduction as a new crop in the United States (Siler, D. J., and K. Cornish, Industrial Crops and Products, 2: 307-313 (1994); U.S. Pat. No. 5,580,942; U.S. Pat. No. 5,717,050). Because only about 10% of the guayule biomass is used for latex, sustainable commercialization of guayule has to be accompanied by an economic use of the residual solid matter remaining after latex extraction (termed ‘guayule bagasse’). The residual resin in the guayule bagasse coupled with the fact that it is collected in one place makes it what is termed an opportunity fuel that manifests itself as feedstock for co-located biofuel production.

Guayule bagasse was one of the biomass feedstocks named in U.S. Pat. No. 4,678,860 for producing liquid fuels indirectly by fluidized-bed gasification followed by Fischer Tropsch synthesis. Since the first step of this process thermally converts the biomass to synthesis gas (hydrogen and carbon monoxide), the process is not considered to be a direct liquefaction step which converts the biomass (i.e., cellulose, hemicellulose, lignin and other common plant components) into liquid fuel molecules. Pyrolysis, another thermochemical process, decomposes the biomass polymers in the absence of oxygen, producing liquid fractions that are significant compared to gaseous and charcoal (biochar) side products. It is likely that the inventors of the above-mentioned patent had to use the gasification route because the pyrolysis of guayule bagasse using the then existing traditional pyrolysis approaches results in a highly viscous material that is extremely difficult to utilize in any application or further refine due to its extreme viscosity. (Boateng, A. A., et al., Fuel. 88: 2207-2215 (2009)).

The traditional fast pyrolysis process typically uses an inert medium such as nitrogen to create a pyrolysis oil, bio-char, and synthesis gas of varying proportions based on the feedstock and process conditions, such as temperature, heat rate, and flow rate. One pyrolysis system developed for USDA is a bubbling fluidized bed of sand that employs a cyclone, a series of condensers, and an electrostatic precipitator (Boateng, A. A., et al., Ind. Eng. Chem. Res., 46: 1891-1897 (2007); Boateng, A. A., et al., Ind. Eng. Chem. Res., 47: 4115-4122 (2008)). Typical pyrolysis oil yields for woody and herbaceous lignocellulosic feedstock would exceed 60 wt %, but the pyrolysis oil would comprise over 400 oxygenated compounds with total oxygen content exceeding some 30-50 wt %. This high level of oxygen is responsible for the thermally unstable characteristics the traditional pyrolysis oils possess. Owing to the high oxygen content, conventional pyrolysis oil is immiscible with petroleum and over time oligomerizes to heavy molecular weight components, and it also polymerizes and forms tars at elevated temperatures (60°-100° C.). High oxygen content is also the reason why difficulties persist in co-processing pyrolysis oil as petroleum fuel blend-stock with various feed streams in existing refinery infrastructure such as the fluid catalytic cracking (FCC) process. Even in high dilutions, traditional fast pyrolysis oil has proved to be a problematic fuel precursor for these processes. For example, W. R. Grace processed 3% pyrolysis oil made of pine wood containing 53 wt % oxygen with vegetable oil (VGO) in their pilot FCC unit with great difficulty (W. R. Grace, Catalagram No. 113, Spring 2013). They observed that co-feeding pyrolysis oil resulted in more coke, less gasoline, and excessive production of CO and CO₂ in the product gas. Unfortunately their results are consistent with the observations of other researchers who have processed high oxygen containing pyrolysis oils; for example, Lappas, et al. co-processed the heavy fraction of thermally hydrotreated biomass flash pyrolysis liquid with VGO without much success (Lappas, A. A., et al., Catalysis Today, 145: 55-62 (2009); Bielansky, P., “Alternative Feedstocks in Fluid Catalytic Cracking,” PhD Thesis, Vienna University of Technology, Institute of Chemical Engineering, March 2012; Al-Sabawi, N., et al., Energy and Fuels, 26: 5355-5372 (2012)). Petrobras (Brazil) also co-processed raw bio-oil with 51 wt % oxygen and gasoil in an FCC unit at a demonstration scale injecting as much as 20% bio-oil. While they reported some success in carbon conversion due to the heavy loading, the aforementioned problems persisted due to issues associated with appropriate injection location of the bio-oil and the VGO streams because the raw bio-oil and regular petroleum streams were totally immiscible (Pinho, A. R., Almeida, M. B. B., Mendes, F. L., Ximenes, V. L., Casavechia, L. C., Fuel Processing Technology, 131:159-166 (2015). Use of existing hydrogenation technologies for upgrading such oils has been equally problematic with highly oxygenated feeds of the pyrolysis oil type. Pumping issues, fouling of catalyst beds, and excessive hydrogen use are just some of the challenges that have plagued pyrolysis oil use as a fuel intermediate. Another consequence of using highly oxygenated pyrolysis oils, as speculated by W. R. Grace, is that perhaps the exothermic reactions of the oxygenated molecules in the pyrolysis oil tend to reduce the heat requirements for co-processing pyrolysis oil with VGO.

There have been efforts to find novel processing strategies and/or feedstock selectivity that address bio-oil stability issues and enable effective co-processing for various applications. These strategies include the separation of critical chemical components within bio-oils, production of an intermediate bio-oil product that can support interim markets (e.g., home heating oil), and ultimately production of hydrocarbons suitable for refining into transportation fuels. Thus far the process strategy of choice has been catalytic fast pyrolysis (CFP) that uses heterogeneous zeolite type cracking catalysts which are capable of shifting the reaction pathways to low oxygen content products (U.S. Pat. No. 8,404,910; U.S. Pat. No. 8,519,203). For example, CFP protonation of the substrate molecules leads to the formation of carbocations which initiate dehydration, dehydrogenation, decarbonylation, and decarboxylation reactions to produce olefins that oligomerize and cyclize into aromatic hydrocarbons (Mullen, C. A., et al., Energy Fuels, 25: 5444-5451 (2011)):

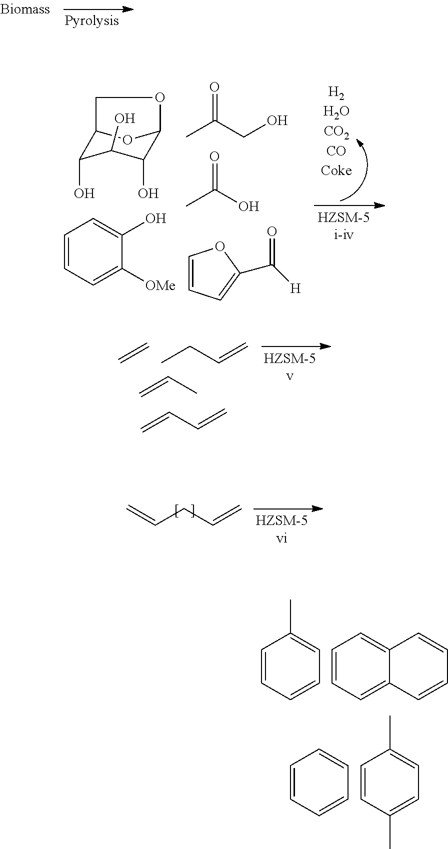

Pyrolysis oils with oxygen contents of <12 wt % and containing some hydrocarbon molecules have been created over HZSM-5 catalysts (W. R. Grace, Catalagram No. 113, Spring 2013; Carlson, T. R., et al., Chem. Sus. Chem., 1: 397-400 (2008); Mullen, C. A., and A. A. Boateng, Ind. Eng. Chem. Res., 52: 17516-17161 (2013); Rezaei, P. S., et al., Appl. Cat. A., 469: 490-511 (2014); Mihalcik, D. L., et al., J. Analytical and Applied Pyrolysis, 92: 224-232 (2011)). Gallium-exchanged ZSM-5 catalysts have recently been utilized to upgrade biomass derived streams during catalytic pyrolysis, and this has further increased production of aromatic hydrocarbons (Cheng, Y., et al., Angew. Chem. Int. Ed., 51: 1387-1390 (2012)). While the relatively low oxygen pyrolysis oil lends itself to only mild upgrading conditions to get closer to drop-in fuels, there are several process issues associated with CFP, including catalyst deactivation and robustness. Owing to the small sizes of the microporous structure associated with zeolite catalysts (˜5 Å), some undesired reactions take place external of the surfaces of the catalysts and this, combined with the inherent hydrogen deficiency of the biomass, results in coke formation, catalyst deactivation, and hence process interruptions.

We have now produced surprisingly high quality, pumpable liquids containing low oxygen compounds from guayule bagasse and/or guayule leaves. Subsequent upgrading via hydrodeoxygenation using on-the shelf noble metal catalysts and/or simple distillation surprisingly produced fuel-grade liquid hydrocarbons having various cut-ranges of gasoline (C5-C7), jet (C8-C12), and diesel (C13-C22), having estimated cetane and octane indices of about 95.3 and about 92.5, respectively.

### SUMMARY OF THE INVENTION

Methods for producing bio-oil from a feedstock (e.g., guayule bagasse and/or guayule leaves), involving (1) pyrolyzing the feedstock in an inert atmosphere in a reactor to produce bio-oil, bio-char and non-condensable gases; (2) recycling about 10 to about 99% of the non-condensable gases to the reactor to produce deoxygenated bio-oil; wherein the method is conducted in the absence of oxygen and wherein the method does not utilize externally added catalysts. Also disclosed are bio-oils produced from such methods. Additionally, the methods further involving (a) first distilling the bio-oil to produce distillates and then reacting the distillates in a hydrodeoxygenation reactor in a chemically reductive atmosphere (e.g., hydrogen environment) to produce hydrocarbons, water, and non-condensable gases or (b) reacting the bio-oil after centrifugation in a hydrodeoxygenation reactor in a chemically reductive atmosphere (e.g., hydrogen environment) to produce hydrocarbons, water and non-condensable gases, and then distilling to produce distilled water and distilled hydrocarbons; and distilled hydrocarbons produced from such methods.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows TGRP (tail gas reactive pyrolysis) process snapshot with integrated control system for establishing sweet spot for quality bio-oil production as described below.

FIG. 2 shows ¹³C NMR analysis of guayule bagasse bio-oils as described below.

FIG. 3 shows conversion of guayule chemical energy content (heat of combustion) into products of the TRGP process (70-85% recycle rate) as described below; basis is 1 kg of guayule bagasse.

FIG. 4 shows composition of reactive gas atmosphere at steady state as described below; 3-run Average HHV=10.99 (+/−0.25) MJ/kg for 70-85% recycle process.

FIG. 5 shows elemental conversion from biomass (guayule bagasse) to TGRP (70-85) products as described below.

FIG. 6 shows guayule TGRP oil is easily distilled “as-is” as described below; T_{cut} (° C.) left to right are respectively: 200, 245 and 354 (250+vac).

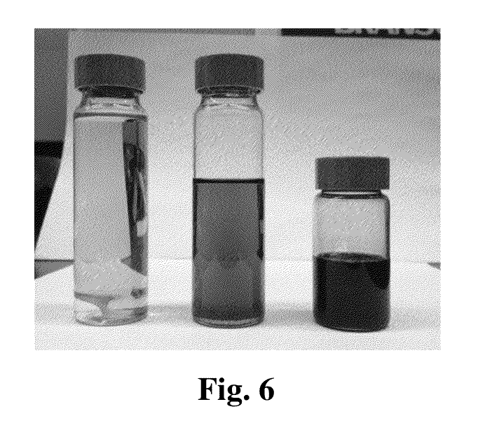

FIG. 7 shows process flow for upgrading of the organic phase of guayule bagasse bio-oil derived from TGRP as described below; the yields are typical over Pt/C, Ru/C and Pd/C.

FIG. 8 shows distillate fractions and carbon dumber distribution of organic phase guayule bio-oil hydrogenated over Ru/C HDO (hydrodeoxygenation) catalyst as described below; approximate cuts: 1, 2, 3-Gasoline; 4, 5-Jet/Diesel; 6-Diesel.

FIG. 9 shows Van Krevelen diagram tracing the guayule pathway to HC fuels as described below; unless otherwise noted, all coordinates are based on guayule feedstock.

FIG. 10 shows molecular weight distribution by carbon number of the upgraded guayule TGRP bio-oil as described below.

FIG. 11 shows distillation curve of the upgraded guayule TGRP bio-oil in comparison with typical crude petroleum as described below.

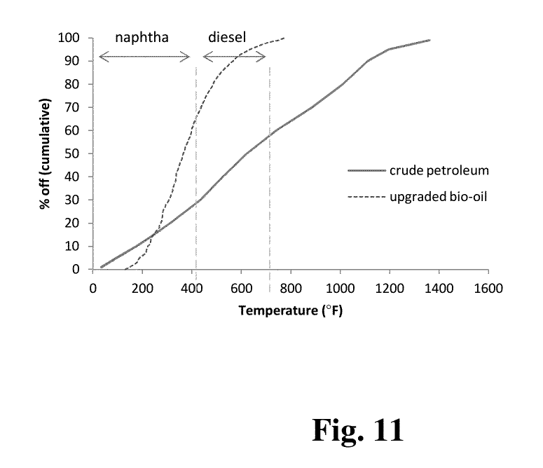

FIG. 12 shows conversion of guayule leaves chemical energy content (heat of combustion) into products of the TRGP process as described below; basis is 1 kg of guayule bagasse.

FIG. 13 shows elemental conversion from Biomass (guayule leaves) to TGRP products as described below.

### DETAILED DESCRIPTION OF THE INVENTION

Disclosed are methods for producing bio-oil (e.g., hydrocarbon compatible or drop-in) from a feedstock (e.g., guayule bagasse and/or guayule leaves), involving (1) pyrolyzing the feedstock in an inert atmosphere in a reactor to produce bio-oil, bio-char and non-condensable gases; (2) recycling about 10 to about 99% of the non-condensable gases to the reactor to produce deoxygenated bio-oil; wherein the method is conducted in the absence of oxygen and wherein the method does not utilize externally added catalysts. Also disclosed are bio-oils produced from such methods. Additionally, the methods further involving (a) first distilling the bio-oil to produce distillates and then reacting the distillates in a hydrodeoxygenation reactor in a chemically reductive atmosphere (e.g., hydrogen environment) to produce hydrocarbons, water, and non-condensable gases or (b) reacting the bio-oil after centrifugation in a hydrodeoxygenation reactor in a chemically reductive atmosphere (e.g., hydrogen environment) to produce hydrocarbons, water and non-condensable gases, and then distilling to produce distilled water and distilled hydrocarbons; and distilled hydrocarbons produced from such methods.

Herein we present the use of a resin-containing feedstock, guayule bagasse and/or leaves, in combinations with the novel reaction pathways offered by the TGRP process, to create a pyrolysis liquid fuel intermediate that surprisingly solves pyrolysis oil co-processing issues. This fuel intermediate is surprisingly also easily amenable to simple petroleum upgrading and separation processes, thereby allowing for production of hydrocarbon fractions seamless with existing transportation fuels.

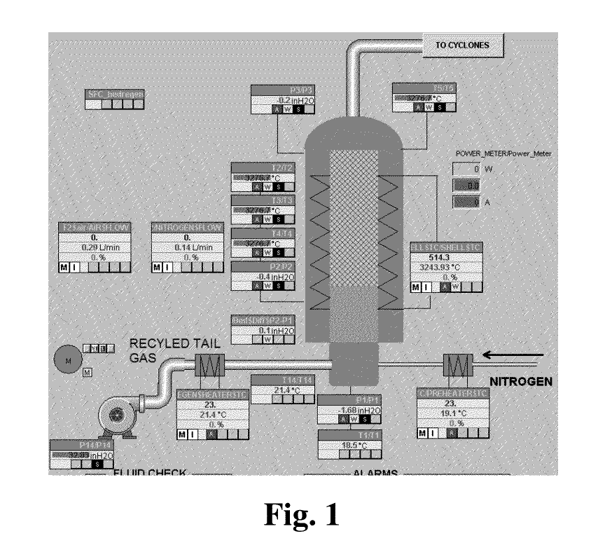

Guayule and Tail Gas Reactive Pyrolysis (TGRP): As a pyrolysis feedstock, guayule bagasse has a higher energy content, about 22 MJ/kg HHV, compared to 17-18 MJ/kg for typical woods. The inherently higher energy content is attributed to the residual resins from latex extraction which result in a higher C/O and H/C ratio than typical woods (Table 1). In 2009, USDA was first to successfully produce pyrolysis liquids from guayule bagasse using their fluidized-bed fast pyrolysis system, “The Kwesinator” (Boateng, A. A., et al., Fuel, 88: 2207-2215 (2009)). Despite high yield of the organic fraction of the oil (49 wt %), high HHV (31 MJ/kg), and relatively lower oxygen content, attributed perhaps to the presence of plant resins and residual rubber components (Table 3), the bio-oil viscosity was extremely high. The extreme viscosity severely restricted the direct utilization or upgrading of the resulting bio-oil to either fuels or chemicals. For example, these properties made it impossible or nearly impossible to pump this product to a reactor for upgrading or pump to spray atomization to effect combustion “as is.” It also could not be distilled or separated via centrifugation or other physical methods. We have now solved this problem by surprisingly producing even more deoxygenated and less viscous bio-oil from guayule bagasse using USDA's Tail Gas Reactive Pyrolysis (TGRP) process (FIG. 1), surprisingly without resorting to a catalytic fast pyrolysis process, thereby saving catalyst cost and associated coking issues (U.S. patent application Ser. No. 13/777,020, filed 26 Feb. 2013; Mullen, C. A., et al., Energy and Fuels, 27: 3867-3874 (2013)). While TGRP bio-oils from various lignocellulosic biomases are distillable, that derived from guayule is more fungible and even refinable.

The tail gas reactive pyrolysis (TGRP) process distinguishes itself from conventional fast pyrolysis by the use of a reactive atmosphere comprised of biomass-derived permanent co-product gases rather than the traditional inert atmosphere (100% N₂) to sustain pyrolysis (U.S. patent application Ser. No. 13/777,020 filed 26 Feb. 2013 [0265.12]; Mullen, C. A., et al., Energy and Fuels, 27: 3867-3874 (2013)). As shown in the tables below (Tables 3 and 4), surprisingly a significant deoxygenation effect and greatly increased concentration of aromatic hydrocarbons is the result of TGRP when using guayule bagasse and/or guayule leaves. TGRP utilizes certain conditions, a so-called “sweet spot” of blended gas composition that optimizes the deoxygenation pathways.

Pyrolysis can be performed on a bubbling fluidized bed pyrolysis system, for example see the one previously described by Boateng et al. (Boateng, A. A., et al., Ind. Eng. Chem. Res., 46: 1891-1897 (2007); Boateng, A. A., et al., Energy Fuels, 24: 6624-6632 (2010); U.S. patent application Ser. No. 13/777,020, filed 26 Feb. 2013; Mullen, C. A., et al., Energy and Fuels, 27: 3867-3874 (2013)). Pyrolysis can be conducted at a fluidized bed temperature of between about 450° and about 550° C. (e.g., 450° to 550° C.) and reaction/residence times from about 0.1 to about 5 seconds (e.g., 0.1 to 5 seconds; preferably about 0.1 to about 1 second (e.g., 0.1-1 second)). Control of the temperatures, and feed rate and data collection can be accomplished through use of standard control systems (e.g., Siemens PCS7 control system). The pyrolysis reactor described above, a complete schematic of the system is provided in FIG. 1, can be modified for operation on recycled product gas by including a regenerative blower with an inlet port connected to the ESP outlet to return ESP tail gases to the fluidized bed plenum upon reheating through an electric heater. A remotely controlled gas outlet valve in the blower inlet line allows for the discharge of the preheated returned gases to maintain a constant system volume. A pressure transmitter in the blower inlet line can be integrated with the control system to modulate the gas outlet valve. The regenerative blower can be sized to provide sufficient flow and head to fluidize the sand bed. The system can be flushed with an inert atmosphere (e.g., nitrogen) during heating to remove system air. A small amount of nitrogen (<0.5 L/min) may be required to flow into the feed drop tube to maintain a positive pressure throughout the system as well as to aid feedstock flow.

As noted above, the methods involve recycling about 10 to about 99% (e.g., 10-99%) of the non-condensable gases to the reactor, preferably about 40 to about 90% (e.g., 40-90%), preferably about 60 to about 85% (e.g., 60-85%), preferably about 65 to about 80% (e.g., 65-80%), preferably about 70% (e.g., 70%) non-condensable gases to the reactor to produce deoxygenated bio-oil.

Generally, the combination of benzene, toluene and xylene produced after recycling the non-condensable gases is about 5 times (e.g., 5 times; preferably about 10 times (e.g., 10 times), preferably about 15 times (e.g., 15 times), more preferably about 20 times (e.g., 20 times), and most preferably about 25 times (e.g., 25 times)) the combination of benzene, toluene and xylene produced with no recycling of the non-condensable gases, preferably

Generally, the products produced after recycling the non-condensable gases have a C:O ratio of at least about 1.6 times (e.g., at least 1.6 times; preferably at least about 1.9 times (e.g., at least 1.9 times), more preferably at least about 4.3 times (e.g., at least 4.3 times), most preferably at least about 5.3 times (e.g., at least 5.3 times)) the C:O ratio of products produced with no recycling of the non-condensable gases.

Generally, the products produced after recycling the non-condensable gases contain about 70% (e.g., 70%; preferably about 50% (e.g., 50%)) of the CO₂ compared to products produced with no recycling of the non-condensable gases.

Generally, the products produced after recycling the non-condensable gases contain about two times (e.g., two times; preferably about 20 times (e.g., 20 times)) more H₂ compared to products produced with no recycling of the non-condensable gases.

Generally, the products produced after recycling the non-condensable gases contain about two times (e.g., two times; preferably about six times (e.g., six times)) more CH₄ compared to products produced with no recycling of thenon-condensable gases.

Generally, the products produced after recycling thenon-condensable gases contain about 1 mole % (e.g., 1 mole %; preferably about 2.7 mole % (e.g., 2.7 mole %)) C₂H₆ compared to products produced with no recycling of thenon-condensable gases which contained about 0 to about 0.4 mole % C₂H₆.

Generally, the products produced after recycling thenon-condensable gases contain about 1 mole % (e.g., 1 mole %; preferably about 2.6 mole % (e.g., 2.6 mole %)) C₃H₈ compared to products produced with no recycling of the non-condensable gases which contain about 0 to 0.1 mole % C₃H₈.

Generally, the products produced after recycling the non-condensable gases contain about 1.6 to about 2.8 times more (e.g., 1.6 to 2.8 times) MJ/kg compared to products produced with no recycling of the non-condensable gases.

“Optional” or “optionally” means that the subsequently described event or circumstance may or may not occur, and that the description includes instances in which the event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

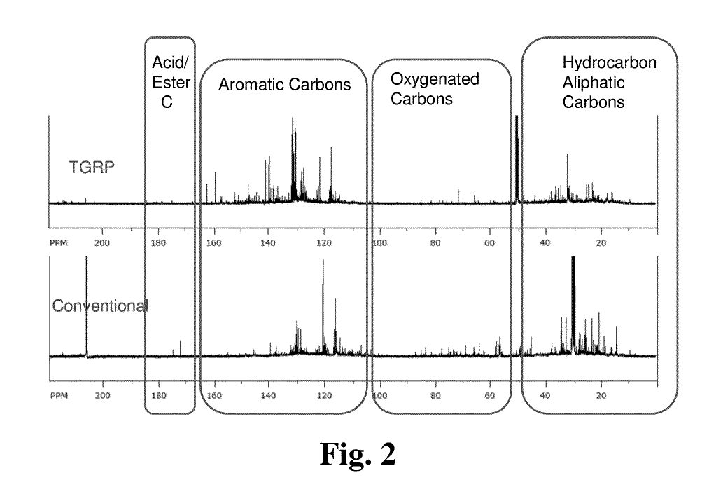

TGRP Products and Distribution: The useable organic phase of the TGRP oil from guayule bagasse was less than that produced from conventional pyrolysis but still significant. The two entries for the guayule TGRP process (Table 2) reflect the existence of the best gas composition for best results, named the “sweet spot”, achieved by a tight control of the ratio of recycled biomass derived gas to added nitrogen comprising the atmosphere for the pyrolysis reaction along with the temperature and pressure of the system (FIG. 1); thus the TGRP does not utilize the traditional inert atmosphere (100% N₂). When the reactive gas mixture was below the optimum level of biomass derived reactive gas in the atmosphere (e.g., 45% to 65% of the atmosphere) deoxygenation effects were still seen compared with conventional fast pyrolysis bio-oil but to a lesser extent than at the “sweet spot” (i.e., 70 to 85% of the atmosphere). The oil yield of 34 wt % of bagasse is a reduction from the 60 wt % encountered in conventional fast pyrolysis which is due to desirable deoxygenation reactions that occur which are surprisingly similar to that experienced by catalytic fast pyrolysis (CFP). While CFP cracks and deoxygenates the pyrolysis vapors over the catalyst surface, the TGRP uses a reactive atmosphere to create the same effect. The residual resin and latex in the guayule bagasse precursor enhance pathways that break carbon-oxygen bonds resulting in the release of even more oxygen as water. While similar yields can be experienced for switchgrass, it is the composition and hydrocarbon concentration of the guayule-based TGRP bio-oil that gives its high quality and ‘refinability’ advantage (Table 3). While carbon content of 80 wt % of the liquid product facilitated by TGRP for other cellulosic feedstock such as switchgrass is impressive, surprisingly the O-content for guayule bio-oil from the same process was significantly lower, thereby making guayule bio-oil surprisingly highly energy dense with a higher heating value approaching 40 MJ/kg. The low acidity, as measured by the total acid number (TAN), was testimony to the surprising reduction of carboxylic acids that cause instability in traditional pyrolysis oils. Table 4 shows that acetic acid and the highly oxygenated sugar monomer levoglucosan were surprisingly diminished, giving way to increased BTEX (benzene, toluene, ethyl benzene and xylenes), making it a high-quality feed stream for further upgrading at mild conditions. Alkyl phenols were also surprisingly increased in concentration, reflecting better net depolyemrization of lignin components, partly contributing to the decreased viscosity of the bio-oils produced from the guayule bagasse TGRP process. FIG. 2 further depicts the difference in composition of guayule bio-oils produced using the TGRP process and conventional fast pyrolysis via their ¹³C NMR spectra. The spectra illustrate that TRGP-based pyrolysis oils have more aromatic content (peaks between 110-170 ppm) and fewer oxidized aliphatic carbon atoms (those with C—O single bonds peaks between 50-110 ppm and ester/acid carbons at 165-185 ppm) than those produced using conventional fast pyrolysis.

Another minor co-product of the process was surprisingly an aqueous liquid phase since conventional pyrolysis of guayule bagasse did not produce a separate aqueous phase. Because of the deoxygenation reactions, more water was produced in the TRGP process, and the oil phase was more hydrophobic in view of the high C/O ratio and to a less extent high H/C ratio. This led to an aqueous phase that was more dilute than that encountered with conventional fast pyrolysis. For guayule TGRP, this aqueous phase represented less than 5 wt % of the organic matter produced. The aqueous phase contained mostly residual high oxygen components such as acetic acid, acetol, and some phenols (Table 5).

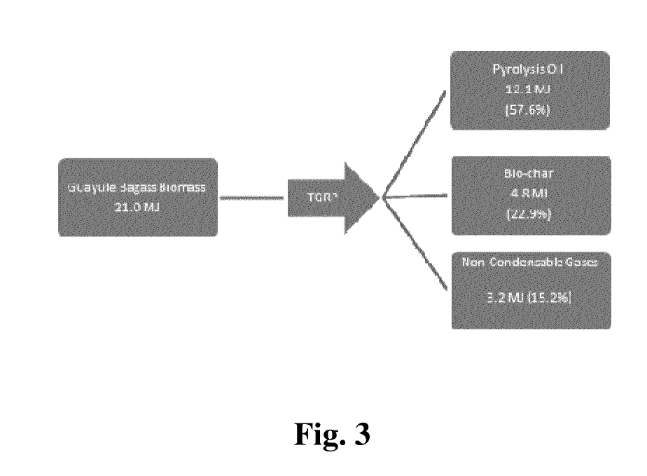

Heat and Material Balance: The distribution of energy from the guayule to products is presented in FIG. 3. Surprisingly over 57% of the original energy in the feedstock goes to the pyrolysis oil. This is a higher amount than is achieved by other lignocellulo sic feedstocks, including wood, grasses (e.g., switchgrass) or agricultural residues (e.g., corn stover) and even by pyrolysis of guayule via conventional pyrolysis.

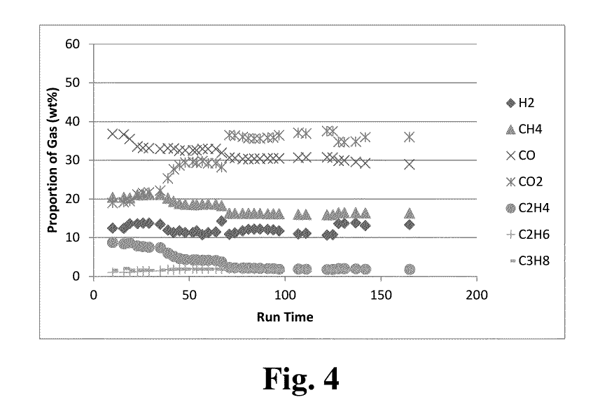

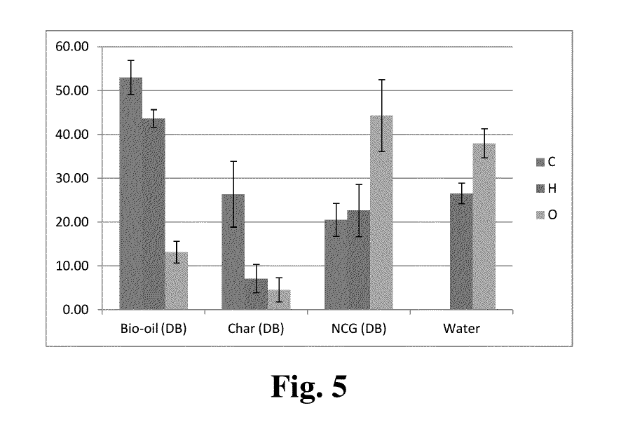

In comparison to NCG of other pyrolysis processes, the quality of the bio-oil was surprisingly not the only energy-dense phase; the non-condensable gas (NCG) was also energy dense with high concentrations of combustible gases including CO and light hydrocarbon gas (FIG. 4; Table 17). This allowed autogenic combustion for energy needed for the endothermic pyrolysis reaction without the need for added or external source of process heat. FIG. 5 shows how the carbon, hydrogen, and oxygen in the guayule bagasse was distributed in the TRGP products, and depicts the deoxygenation effect on the pyrolysis oil wherein oxygen from biomass was mainly released from the biomass as NCG (CO & CO₂) and also as water. Meanwhile, most carbon was surprisingly retained in the bio-oil rather than removed via bio-char or NCG, leading to the high C/O ratio observed for the pyrolysis oil.

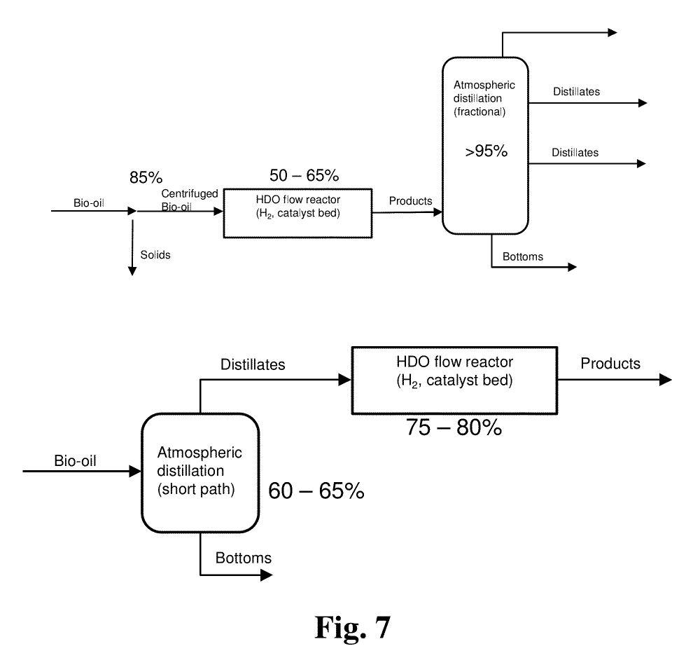

Continuous hydrodeoxygenation (HDO) of TGRP product: While atmospheric distillation of conventional bio-oil halts at 100°-115° C. vapor temperature, primarily due to thermal instabilities, the high quality TGRP oil allows for distillation in high yields and gives greater processing flexibility at temperatures up to about 350° to about 400° C. However, HDO will still be necessary before its integration in existing refinery feed streams as either blend-stock or drop-in fuel, and for that the guayule-based TGRP bio-oil brings unique advantages to upgrading via HDO. One unique characteristic of the TGRP bio-oil is that the high quality nature afforded the potential to first distill and then hydrotreat or alternatively hydrotreate first and distill the hydrotreated products into hydrocarbon blends from cut fractions. While both process routes have been explored and essentially result in comparable yields, we followed the latter process flow (FIG. 7a) to illustrate guayule biorefining. The yields illustrated in the figure are typical for HDO over common HDO catalysts including Pt/C, Ru/C, and Pd/C, and suggest that the final distillate products surprisingly constituted a 52.5 wt % yield from the organic phase guayule bio-oil (surprisingly a total of about 16.65 wt % from the bagasse). Herein, we present results of the post-TGRP upgrading process for HDO over carbon-supported catalyst (Pt/C, Ru/C, Pd/C, Table 6).

For all the hydrotreating catalysts tested, reasonable yields and fuel properties were attained for LHSV between 0.46-0.61 hr⁻¹, which surprisingly was significantly larger than the standard 0.1-0.2 hr⁻¹ required for effective hydrotreatment of traditional bio-oil through the current upgrading state-of-the art technology using a two-stage reactor (Elliott, D., Energy & Fuels, 21: 1792-1815 (2007); Zacher, A. H., et al., Green Chemistry, 16: 491-515 (2014)). Hence, this large improvement was surprisingly a reflection of the TGRP oil quality and not the catalyst. At the same time, the ruthenium-catalyzed HDO produced fuel with the lowest moisture, oxygen, and acidity, as well as the highest organic yield. As indicated by GC-MS results, all of the catalysts produced significant amounts of fuel-quality compounds (e.g., naphthenes, paraffins, aromatics), and Ru/C HDO also produced the largest concentrations of these compounds.

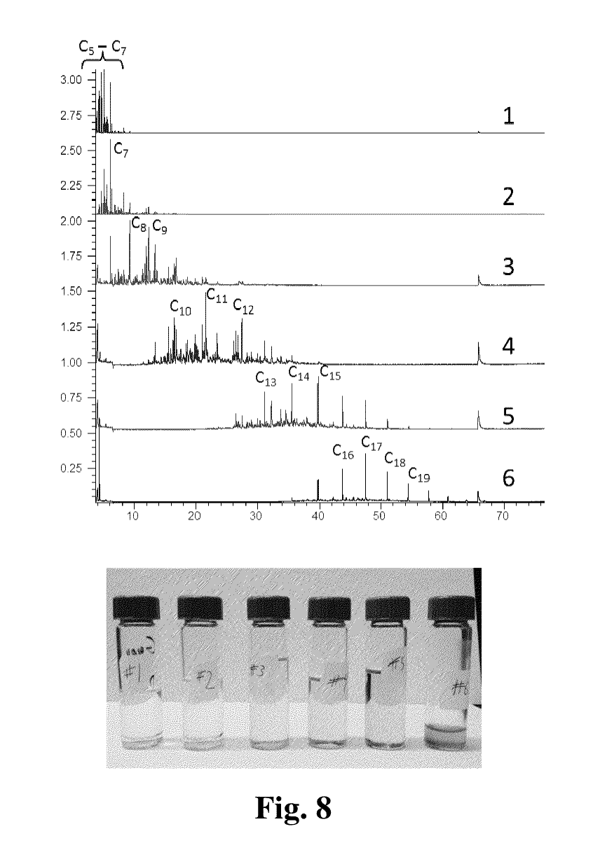

While all bio-oil HDO products were distilled, we present the results from distillation of the Ru/C-catalyzed HDO products (Table 7). For all the products from HDO of centrifuged bio-oil, distillation was performed in greater than a 95% total yield. While the GC-MS results are only representative of compounds for which standards were developed, they nevertheless account for a large portion of the distillates. Octane and cetane numbers reported for each fraction are averages of the dominant components, based on calculated numbers and/or reported literature values for the compounds (Albahri, T. A., et al., Fuel Chemistry Division Preprints, 47: 710-711 (2002); Do, P. T. M., et al., Catalysis, 20: 33-64 (2007)). Based on boiling points, only the relevant parameter(s) (i.e., octane and/or cetane) accompany data for each fraction. Fractions 4-6 account for heavier straight-chain hydrocarbons in the jet/diesel fuel range, which are better depicted in FIG. 8; the relatively high purity (50-100% pure) of straight-chain paraffins (marked by C₁₀, C₁₁, etc.) in fractions 4-6 is unprecedented for pyrolysis/HDO in general. The chromatograms for fractions 5-6 indicate that they were nearly entirely straight-chain paraffins (indicated by Cₓ values), which is surprisingly very atypical of pyrolysis processes. Without being bound by theory, the composition of the guayule bagasse (particularly its resin content) contributes to this phenomenon and makes it particularly valuable for specialty (e.g., aviation) fuels applications which require straight-chain compounds.

In order to illustrate the flexibility afforded by the TGRP bio-oil, we present results from guayule bagasse TGRP bio-oil that was distilled directly and was then subjected to HDO over both Pt/C and Ru/C (FIG. 7). Results from both the distillation and HDO of distillates are presented in Table 8. When compared with centrifuged oil, the TGRP bio-oil distillates surprisingly possessed properties (e.g., higher HHV, lower density, much lower moisture) significantly closer to fungible hydrocarbon fuel. In addition, distillation directed the very high molecular weight compounds into the bottoms residue products, which normally would end up coking, plugging, and deactivating the catalyst bed.

ASTM analyses of guayule TGRP bio-oil post-HDO: A mixture of upgraded guayule TGRP bio-oil was tested according to ASTM standards for fuel quality. This mixture consisted of the HDO products catalyzed by Ru/C and Pt/C. Table 9 summarizes the ASTM methods used, as well as some quantified results from those tests. The ASTM results verify most of the corresponding results from our laboratory tests. The TAN value of 1.08 was consistent with the R2˜5.0 values obtained and the presence of some sulfur at 335 ppm was reflective of the relatively high sulfur content of the feedstock.

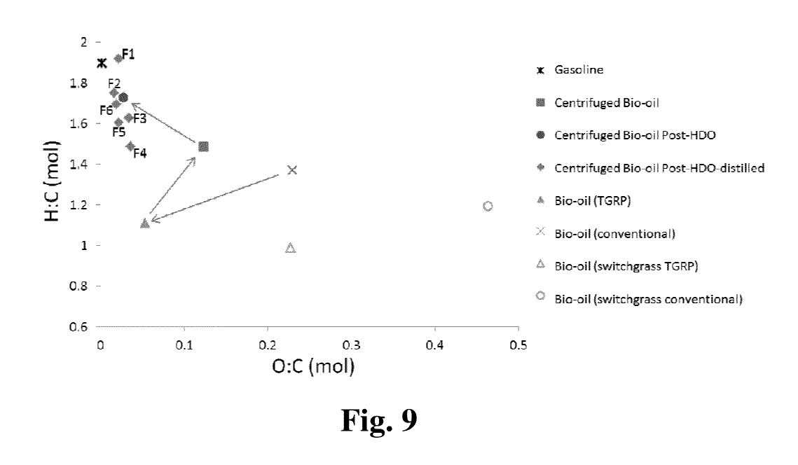

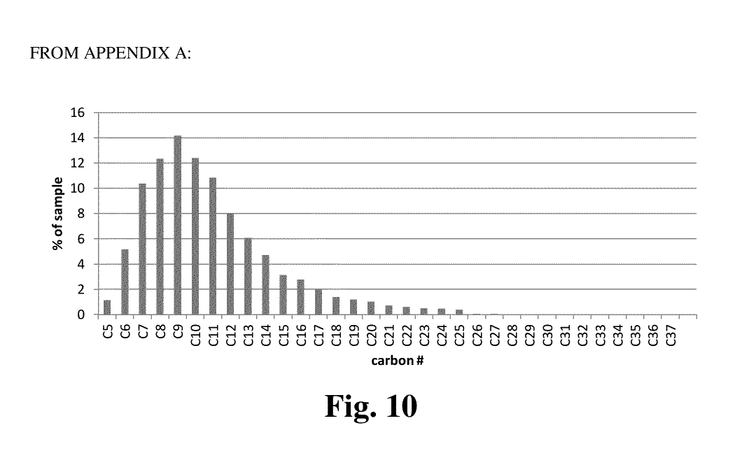

The plot in FIG. 9 shows the amount of sample that contributed to each molecular weight. The majority of the sample (66%) fell at C12 and below, which falls within the gasoline (naphtha) range (verified by simulated distillation, FIG. 10). Beyond C12, the molecular weights increased through the diesel range, with C37 being the highest observable molecular weight. The greatest fraction of naphtha fell within the C8-C10 range. The aforementioned observations explain the surprisingly low cetane number (Table 5) of the overall mixture.

FIG. 10 is the distillation curve for the whole upgraded sample. Based on FIG. 10, nearly all components from the TGRP bio-oil that were heavier than diesel range (>750° F. boiling point) were surprisingly eliminated, in contrast to a typical crude petroleum.

Thus we have disclosed processes for producing a special bio-oil from guayule bagasse using pyrolysis processes that employed a reactive gas environment to formulate a special intermediate bio-oil product that, in turn, allowed use of conventional hydrotreating with conventional noble metal catalysts and a simple distillation process to further synthesize hydrocarbon fuels (drop-in) from the bio-oil. The guayule tail gas reactive pyrolysis (TGRP) process comprises pyrolyzing guayule bagasse in a fluidized-bed reactor in the presence of a reactive and flammable tail gas comprising (CO˜30%, CH4˜16%, CO2˜40%, H2˜10%, >C2H4˜traces) generated in the pyrolysis process and without the use of catalyst to thereby produce bio-oil with 31-37.5 MJ/kg (C/O molar ratio of 4-14) in organic yields of 34-40 wt % and further processing the bio-oil by centrifuging it (85 wt % yield) then subjecting the centrifuged oil to continuous hydrotreating over a common noble metal (Pt, Ru or Pd) on a carbon support to 50-65 wt % yields followed by distillation to >95 wt % yield to result in a total of 18-22 wt % (of guayule bagasse) hydrocarbon liquid fuels in 30.4% gasoline (C5-C7), 37% jet (C8-C12) and 24% diesel (C13-C22) having estimated cetane and octane indices of 95.3 and 92.5, respectively.

Pyrolysis of Guayule Leaves: To demonstrate the ability of the TGRP process to convert the entity of the guayule plant value chain, we also studied the conversion of guayule leaves to bio-oil and subsequent refining to upgraded fuel and chemical products. The composition of the guayule leaves (Table 10) was different than that of the bagasse, with the main differences being the higher ash content (>16 wt %) and the higher nitrogen content (2.6 wt %, dry ash free, daf). The nitrogen content of the leaves is the result of the concentration of the plant proteins within the leaf; the guayule leaves had a protein content of 16.4 wt % (daf). We performed the TGRP of the guayule leaves under two conditions, one where the reaction atmosphere contained 72 vol % recycled reactive gas atmosphere and one where the reaction atmosphere was 48 vol % recycled reactive gas.

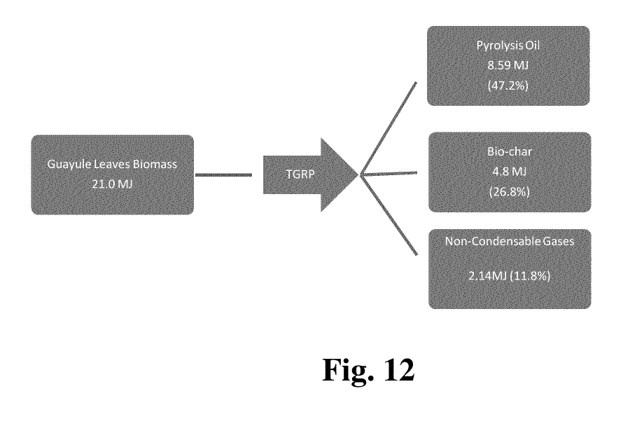

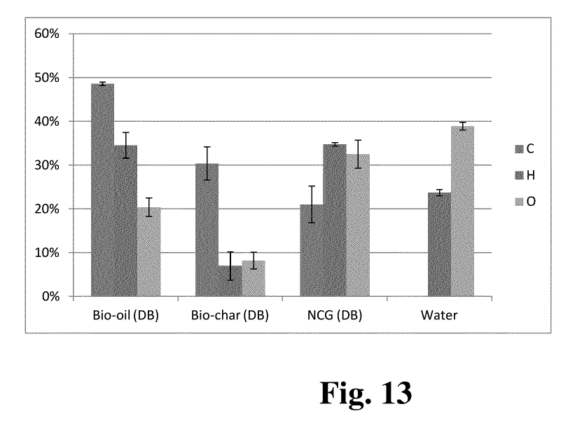

Table 11 contains the yields of the products obtained from the TGRP of guayule leaves and provides a comparison with switchgrass (SWG) from conventional and TGRP pyrolysis. As shown, the distribution of products from the two TGRP conditions was very similar. Tables 12, 13 and 14 provide the analysis of the bio-oil products. As shown in Table 12, the pyrolysis oil of guayule leaves was surprisingly deoxygenated, less acidic, and had a higher energy content than those produced from switchgrass via conventional pyrolysis. The oils collected at the two processing conditions were surprisingly similar. Surprisingly most of the oxygenates detected were phenolics, with only trace amounts of furans, acetic acid, acetol, or levoglucosan detected (Tables 12 and 13). FIGS. 12 and 13 depict the conversion of chemical energy and elements of the guayule leaves to the pyrolysis process, respectively. Surprisingly about 50% of the chemical energy in the leaves was recovered in the bio-oil, and about 50% of the carbon as well; much of the oxygen was converted to water and non-condensable gases, demonstrating the deoxygenation effect of the protein and is reflected in the high C/O ratio of the bio-oil. Although it appears that the effect of TGRP process was lessened for the high protein leaves, the bio-oils from the TGRP process of guayule leaves surprisingly showed no signs of high viscosity components that plagued previous attempts to process gauayule biomass via conventional pyrolysis (Boateng, A. A., et al., Fuel, 88: 2207-2215 (2009)).

Table 15 shows the surprising results from distillation of guayule leaves bio-oil. Like guayule bagasse bio-oil, the leaves-based oil was easily distillable at high temperatures with significant yields overall (61.5% total distillate yield). Lighter fractions were marked by low densities and lower wt % oxygen. Even without distillation, the guayule leaves bio-oil can be centrifuged and subsequently undergo HDO much in the same way as guayule bagasse. Table 16 compares the centrifuged bio-oils from both bagasse and leaves, before and after HDO. Centrifugation yields ranged from 84-88% for all oils, with the heavy fraction consisting of solids and water. HDO of both oil types resulted in nearly identical results, with product yields at 50%. While the leaves bio-oil HDO product contained less oxygen, the higher heating value for the bagasse product was higher.

Discussion: Others have previously successfully synthesized hydrocarbons from pyrolysis oil using catalytic HDO followed by atmospheric distillation. Pacific Northwest National Laboratory (PNNL) did so using a two-stage reactor system (Elliott, D., Energy & Fuels, 21: 1792-1815 (2007)). In that process, the first stage comprised a fixed-bed reactor of CoMo/C sulfided catalyst, where the reactive acids and aldehyde groups of the pyrolysis liquids were stabilized at 150°-200° C. The stabilized bio-oil was deoxygenated by high-pressure hydrogen over carbon supported precious metal catalysts in the second fixed-bed reactor. The two-stage process was capable of deoxygenating bio-oil to <1% oxygen with a time-on-stream of 600-700 hours (including regeneration cycles) before significant plugging occurred. UOP used this setup to synthesize the 2% aromatic content required for jet fuel and blended it with synthetic paraffinic kerosene (Bio-SPK). Boeing tested this blend for engine performance in 2009 (Bertelli, C., “Current Status of Biofuels Production and Use for Commercial Aviation”, BIO 2010—V Seminario Latinamericano y del Caribe de Biocombustibles, Santiago, Chile, 17-18 Aug. 2010). The two-stage process has also been the standard for estimating economic viability of biorefining technologies, including that published by PNNL which reported a projected minimum selling price of pyrolysis-based gasoline at $2.32 per gallon (Jones, S. B., and J. L. Male, “Production of gasoline and diesel from biomass via fast pyrolysis, hydrotreating and hydrocracking: 2011 state of technology and projections to 2017”, Pacific Northwest National Laboratory, February 2012, PNNL-22133). Two-stage processing is used because of the high levels of oxygenated compounds in traditional pyrolysis oils that require severe conditions, including sulfided catalysts which are anything but environmentally friendly. The quality of our TGRP/guayule bio-oil surprisingly affords the use of only one HDO step coupled with on-the-shelf and more environmentally friendly catalysts which therefore promises to be more economical. Due to the 3-fold increase in effective liquid hourly space velocity (LHSV), higher production rates would be possible for an equal amount of capital costs; LHSV can be further reduced when a two-stage reactor is used. Also, HDO of distillates gave significantly higher yields (60-80%) for equivalent LHSV values for traditional pyrolysis oils. This further implies that catalyst lifetimes would significantly increase, thereby decreasing costs due to catalyst regeneration, catalyst replacement, and process shutdowns for a guayule-TGRP refinery.

Microalgae remnant has been reported to produce aromatic hydrocarbons that could be used to produce drop-in biofuels using catalytic fast pyrolysis. Like most proteinaceous materials such as those previously studied by the us (Boateng et. al. U.S. Pat. No. 8,317,883; Boateng et. al., Energy Fuels, 24: 6624-6632 (2010); Mullen and Boateng, Bioenergy Research, 4: 303-311 (2011)), algae pyrolysis yields stable bio-oils. Miao and Wu (2004) reported that bio-oil produced from heterotrophic Chlorella protothecoides cells had a much lower oxygen content, with a higher heating value (41 MJkg⁻¹), a lower density (0.92 kgl⁻¹), and lower viscosity (0.02 Pas) compared to those of bio-oil from autotrophic cells and wood (Miao, X., and Q. Wu, J. of Biotechnology, 110: 85-93 (2004)). While these numbers are reassuring and comparable to the data on guayule bagasse pyrolysis via TGRP, the cost for algae biorefining via pyrolysis could be prohibitive. Thilakaratne et al. recently estimated a minimum selling price of $1.8/liter for Chlorella vulgaris dewatered, pyrolyzed and upgraded following the two-stage PNNL HDO system (Thilakaratne, R., et al., Fuel, 120: 104-112 (2014)). The high cost was attributed to the high dewatering cost among others including harvest logistics and low fuel yield estimated only to be 10.7 wt % of input biomass. This pales in comparison to the total average fuel yield of 16.65 wt % for guayule bagasse TGRP process reported here that does not require high-cost mechanical dewatering.

In conclusion, the primary pyrolysis liquids (bio-oil) produced from TGRP of guayule bagasse and/or leaves possesses several technical advantages compared with traditional biomass fast pyrolysis of either guayule or other lignocellulosic biomass. We have demonstrated the facile refining of these intermediates into gasoline, jet, and diesel range hydrocarbon cuts. The problems encountered by others in utilization and refining of pyrolysis oils would potentially diminish if the starting materials possessed qualities surprisingly afforded by TRGP-guayule bio-oil.

Our TGRP process produced deoxygenation pyrolysis oil from traditional lignocellulosic biomass and guayule bagasse. However, there are several important differences between the bio-oil products that make the bio-oil produced from the combination of the guayule bagasse feedstock and TGRP unique. While TGRP bio-oils from various lignocellulosic biomasses are distillable, that derived from guayule was surprisingly more fungible and even refinable because the TGRP process surprisingly was able to activate the guayule-specific plant resins and residual rubber components of the bagasse. While carbon content of 80 wt % of the liquid product facilitated by TGRP for other cellulosic feedstock such as switchgrass is impressive, surprisingly the 0-content for guayule bio-oil from the same process was significantly lower, thereby making guayule bio-oil highly energy dense with a higher heating value approaching 40 MJ/kg. The minimum oxygen level observed under the optimized conditions for switchgrass or oak was ˜12 wt %, whereas surprisingly oxygen content of only ˜8 wt % was achieved for guayule bagasse TGRP bio-oil. The guayule TGRP bio-oil surprisingly contained significant amounts of aliphatic hydrocarbons, whereas the TGRP bio-oils from hydrocarbons from switchgrass or oak contain almost only aromatics. This is indicated by the higher H/C ratio for guayule TGRP bio-oil (˜1.2) compared with the other TGRP bio-oils (˜0.8-0.9). This means that guayule TGRP bio-oil surprisingly yielded significant amounts of jet/diesel range in addition to gasoline fractional cuts upon distillation and/or hydrotreating (see FIG. 8) whereas TGRP bio-oils of other biomass will yield nearly entirely only gasoline range fractions. This is surprising because our previous work on pyrolysis of guayule bagasse produced an extremely viscous product that was basically unusable as a fuel or refining feedstock. This viscosity was attributed to the remaining high molecular weight components of the residual rubber and plant resins. There was no reason to think that the TGRP process would result in the production of smaller molecules that resulted in solving the viscosity problem or that it would result in the composition described above.

All of the references cited herein, including U.S. patents, are incorporated by reference in their entirety. Also incorporated by reference in their entirety are the following references: Boateng, A. A., et al., Fuel, 88: 2207-2215 (2009); Boateng, A. A., et al., J. Anal. Appl. Pyrolysis, 87: 14-23 (2009); Boateng, A. A., et al., Energy Fuels, 24: 6624-6632 (2010); Fahmi, R., et al., Fuel, 87: 1230-1240 (2008); Huber, G. W., et al., Chem. Rev., 106: 4044-4098 (2006); Jones, S. B., et al., Production of Gasoline and Diesel from Biomass via Fast Pyrolysis, Hyrdotreating and Hydrocracking: A Design Case; U.S. Department of Energy, Washington, D.C., 2009, DE-ACO5-76RL01830), Mullen, C. A., and A. A. Boateng, Bioenergy Research, 4: 303-311 (2011); Mullen, C. A., et al., Energy and Fuels, 27: 3867-3874 (2013); Patwardhan, P. R., et al., Bioresource Technology, 101: 4646-4655 (2010); U.S. Patent Application Publication Number 20120067773; U.S. patent application Ser. No. 13/777,020 filed 26 Feb. 2013.

Thus, in view of the above, there is described (in part) the following:

A method for producing bio-oil from a feedstock, said method comprising (or consisting essentially of or consisting of) (1) pyrolyzing said feedstock in an inert atmosphere in a reactor to produce bio-oil, bio-char, and non-condensable gases; (2) recycling about 10 to about 99% of said non-condensable gases to said reactor to produce deoxygenated bio-oil (the bio-oil in (1) is it still in the reactor and reacts with the recycled non-condensable gases to produce deoxygenated bio-oil); wherein said method is conducted in the absence of oxygen and wherein said method does not utilize externally added catalysts; wherein said feedstock is selected from the group consisting of guayule bagasse, guayule leaves, and mixtures thereof. The above method, wherein said method is conducted at a temperature of about 350° to about 600° C. (e.g., 350° to 600° C.). The above method, wherein said method is conducted at a temperature of about 400° to about 600° C. (e.g., 400° to 600° C.). The above method, wherein said method is conducted at a temperature of about 425° to about 600° C. (e.g., 425° to 600° C.). The above method, wherein said method is conducted at a temperature of about 450° to about 575° C. (e.g., 450° to 575° C.). The above method, wherein said method is conducted at a temperature of about 475° to about 550° C. (e.g., 475° to 550° C.). The above method, wherein said method comprises recycling about 60 to about 90% (e.g., 60 to 90%) of said non-condensable gases to said reactor to produce deoxygenated bio-oil. The above method, wherein said method comprises recycling about 65 to about 85% (e.g., 65 to 85%) of said non-condensable gases to said reactor to produce deoxygenated bio-oil. The above method, wherein said method comprises recycling about 70 to about 85% (e.g., 70 to 85%) of said non-condensable gases to said reactor to produce deoxygenated bio-oil.

The above method, wherein said feedstock is guayule bagasse. The above method, wherein said method produces non-condensable gases containing about 13 to about 17% (e.g., 13 to 17%) of the energy in said feedstock. The above method, wherein said method produces non-condensable gases containing about 15% (e.g., 15%) of the energy in said feedstock. The above method, wherein said bio-oil contains about 55 to about 60% (e.g., 55 to 60%) of the energy in said feedstock. The above method, wherein said bio-oil contains about 57% (e.g., 57%) of the energy in said feedstock. The above method, wherein said bio-oil has oxygen content of less than about 30 wt % (e.g., less than 30 wt %). The above method, wherein said bio-oil has oxygen content of less than about 20 wt % (e.g., less than 20 wt %). The above method, wherein said bio-oil has oxygen content of less than about 10 wt % (e.g., less than 10 wt %). The above method, wherein said bio-oil has oxygen content of less than about 9 wt % (e.g., less than 9 wt %). The above method, wherein said bio-oil has oxygen content of less than about 8 wt % (e.g., less than 8 wt %). The above method, wherein said bio-oil has oxygen content of less than about 7 wt % (e.g., less than 7 wt %). The above method, wherein said bio-oil has oxygen content of less than about 6 wt % (e.g., less than 6 wt %). The above method, wherein said bio-oil has oxygen content of less than about 5 wt % (e.g., less than 5 wt %). The above method, wherein said bio-oil has oxygen content of less than about 4 wt % (e.g., less than 4 wt %). The above method, wherein said bio-oil has oxygen content of less than about 3 wt % (e.g., less than 3 wt %). The above method, wherein said bio-oil has oxygen content of less than about 2 wt % (e.g., less than 2 wt %). The above method, wherein said bio-oil has oxygen content of less than about 1 wt % (e.g., less than 1 wt %). The above method, wherein said bio-oil has oxygen content is about 0 wt % (e.g., 0 wt %). The above method, wherein said bio-oil has C/O ratio of greater than about 3 (e.g., greater than 3). The above method, wherein said bio-oil has C/O ratio of greater than about 10 (e.g., greater than 10). The above method, wherein said bio-oil has C/O ratio of greater than about 12 (e.g., greater than 12). The above method, wherein said bio-oil has C/O ratio of greater than about 20 (e.g., greater than 20). The above method, wherein said bio-oil has C/O ratio of greater than about 30 (e.g., greater than 30). The above method, wherein said bio-oil has C/O ratio of greater than about 40 (e.g., greater than 40). The above method, wherein said bio-oil has C/O ratio of greater than about 50 (e.g., greater than 50). The above method, wherein said bio-oil has C/O ratio of greater than about 60 (e.g., greater than 60). The above method, wherein said bio-oil has C/O ratio of greater than about 70 (e.g., greater than 70). The above method, wherein said bio-oil has C/O ratio of greater than about 80 (e.g., greater than 80). The above method, wherein said bio-oil has C/O ratio of greater than about 90 (e.g., greater than 90). The above method, wherein said bio-oil has C/O ratio of greater than about 100 (e.g., greater than 100). The above method, wherein said bio-oil has C/O ratio of greater than about 110 (e.g., greater than 110). The above method, wherein said bio-oil has C/O ratio of about 120 (e.g., 120). The above method, wherein said bio-oil has H/C ratio of greater than about 1 (e.g., greater than 1). The above method, wherein said bio-oil has H/C ratio of greater than about 1.1 (e.g., greater than 1.1). The above method, wherein said bio-oil has H/C ratio of greater than about 1.2 (e.g., greater than 1.2). The above method, wherein said bio-oil has H/C ratio of greater than about 1.3 (e.g., greater than 1.3). The above method, wherein said bio-oil has H/C ratio of greater than about 1.4 (e.g., greater than 1.4). The above method, wherein said bio-oil has H/C ratio of greater than about 1.5 (e.g., greater than 1.5). The above method, wherein said bio-oil has H/C ratio of greater than about 1.6 (e.g., greater than 1.6). The above method, wherein said bio-oil has H/C ratio of greater than about 1.7 (e.g., greater than 1.7). The above method, wherein said bio-oil has H/C ratio of greater than about 1.8 (e.g., greater than 1.8). The above method, wherein said bio-oil has H/C ratio of greater than about 1.9 (e.g., greater than 1.9). The above method, wherein said bio-oil has H/C ratio of about 2 (e.g., 2). The above method, wherein said bio-oil has TAN of less than about 80 (e.g., less than 80). The above method, wherein said bio-oil has TAN of less than about 70 (e.g., less than 70). The above method, wherein said bio-oil has TAN of less than about 60 (e.g., less than 60). The above method, wherein said bio-oil has TAN of less than about 50 (e.g., less than 50). The above method, wherein said bio-oil has TAN of less than about 40 (e.g., less than 40). The above method, wherein said bio-oil has TAN of less than about 30 (e.g., less than 30). The above method, wherein said bio-oil has TAN of less than about 20 (e.g., less than 20). The above method, wherein said bio-oil has TAN of less than about 19 (e.g., less than 19). The above method, wherein said bio-oil has TAN of less than about 18 (e.g., less than 18). The above method, wherein said bio-oil has TAN of less than about 17 (e.g., less than 17). The above method, wherein said bio-oil has TAN of less than about 16 (e.g., less than 16). The above method, wherein said bio-oil has TAN of less than about 15 (e.g., less than 15). The above method, wherein said bio-oil has TAN of less than about 14 (e.g., less than 14). The above method, wherein said bio-oil has TAN of less than about 13 (e.g., less than 13). The above method, wherein said bio-oil has TAN of less than about 12 (e.g., less than 12). The above method, wherein said bio-oil has TAN of less than about 11 (e.g., less than 11). The above method, wherein said bio-oil has TAN of less than about 10 (e.g., less than 10). The above method, wherein said bio-oil has TAN of less than about 9 (e.g., less than 9). The above method, wherein said bio-oil has TAN of less than about 8 (e.g., less than 8). The above method, wherein said bio-oil has TAN of less than about 7 (e.g., less than 7). The above method, wherein said bio-oil has TAN of less than about 6 (e.g., less than 6). The above method, wherein said bio-oil has TAN of less than about 5 (e.g., less than 5). The above method, wherein said bio-oil has TAN of less than about 4 (e.g., less than 4). The above method, wherein said bio-oil has TAN of less than about 3 (e.g., less than 3). The above method, wherein said bio-oil has TAN of less than about 2 (e.g., less than 2). The above method, wherein said bio-oil has TAN of about 1 (e.g., 1). The above method, wherein said bio-oil has a concentration of benzene, toluene, ethyl benzene, p-xylene, and o-xylene of more than about 2% (e.g., more than 2%). The above method, wherein said bio-oil has a concentration of benzene, toluene, ethyl benzene, p-xylene, and o-xylene of more than about 3% (e.g., more than 3%). The above method, wherein said bio-oil has a concentration of benzene, toluene, ethyl benzene, p-xylene, and o-xylene of more than about 4% (e.g., more than 4%). The above method, wherein said bio-oil has a concentration of benzene, toluene, ethyl benzene, p-xylene, and o-xylene of more than about 5% (e.g., more than 5%). The above method, wherein said bio-oil has a concentration of benzene, toluene, ethyl benzene, and xylene of more than about 6% (e.g., more than 6%). The above method, wherein said bio-oil has a concentration of benzene, toluene, ethyl benzene, p-xylene, and o-xylene of more than about 7% (e.g., more than 7%). The above method, wherein said bio-oil has a concentration of benzene, toluene, ethyl benzene, p-xylene, and o-xylene of more than about 8% (e.g., more than 8%). The above method, wherein said bio-oil has a concentration of benzene, toluene, ethyl benzene, p-xylene, and o-xylene of more than about 9% (e.g., more than 9%). The above method, wherein said bio-oil has a concentration of benzene, toluene, ethyl benzene, p-xylene, and o-xylene of more than about 10% (e.g., more than 10%). The above method, wherein said bio-oil has a concentration of benzene, toluene, ethyl benzene, p-xylene, and o-xylene of more than about 11% (e.g., more than 11%). The above method, wherein said bio-oil has a concentration of benzene, toluene, ethyl benzene, p-xylene, and o-xylene of more than about 12% (e.g., more than 12%). The above method, wherein said bio-oil has a concentration of benzene, toluene, ethyl benzene, p-xylene, and o-xylene of more than about 13% (e.g., more than 13%). The above method, wherein said bio-oil has a concentration of benzene, toluene, ethyl benzene, p-xylene, and o-xylene of more than about 14% (e.g., more than 14%). The above method, wherein said bio-oil has a concentration of benzene, toluene, ethyl benzene, p-xylene, and o-xylene of more than about 15% (e.g., more than 15%). The above method, wherein said bio-oil has a concentration of benzene, toluene, ethyl benzene, p-xylene, and o-xylene of more than about 16% (e.g., more than 16%). The above method, wherein said bio-oil has a concentration of benzene, toluene, ethyl benzene, p-xylene, and o-xylene of more than about 17% (e.g., more than 17%). The above method, wherein said bio-oil has a concentration of benzene, toluene, ethyl benzene, p-xylene, and o-xylene of more than about 18% (e.g., more than 18%). The above method, wherein said bio-oil has a concentration of benzene, toluene, ethyl benzene, p-xylene, and o-xylene of more than about 19% (e.g., more than 19%). The above method, wherein said bio-oil has a concentration of benzene, toluene, ethyl benzene, p-xylene, and o-xylene of about 20% (e.g., 20%). The above method, wherein said bio-oil has a concentration of benzene of more than about 0.6% (e.g., more than 0.6%). The above method, wherein said bio-oil has a concentration of benzene of more than about 0.7% (e.g., more than 0.7%). The above method, wherein said bio-oil has a concentration of benzene of about 0.8% (e.g., 0.8%). The above method, wherein said bio-oil has a concentration of toluene of more than about 2.5% (e.g., more than 2.5%). The above method, wherein said bio-oil has a concentration of toluene of more than about 2.8% (e.g., more than 2.8%). The above method, wherein said bio-oil has a concentration of toluene of about 3% (e.g., 3%). The above method, wherein said bio-oil has a concentration of ethyl benzene of more than about 0.25% (e.g., more than 0.25%). The above method, wherein said bio-oil has a concentration of ethyl benzene of more than about 0.3% (e.g., more than 0.3%). The above method, wherein said bio-oil has a concentration of ethyl benzene of about 0.35% (e.g., 0.35%). The above method, wherein said bio-oil has a concentration of p-xylene of more than about 2% (e.g., more than about 2%). The above method, wherein said bio-oil has a concentration of p-xylene of more than about 2.2% (e.g., more than about 2.2%). The above method, wherein said bio-oil has a concentration of p-xylene of about 2.4% (e.g., about 2.4%). The above method, wherein said bio-oil has a concentration of o-xylene of more than about 0.4% (e.g., more than about 0.4%). The above method, wherein said bio-oil has a concentration of o-xylene of more than about 0.5% (e.g., more than about 0.5%). The above method, wherein said bio-oil has a concentration of o-xylene of about 0.6% (e.g., 0.6%). The above method, wherein said bio-oil has a concentration of acetic acid of less than about 1% (e.g., less than about 1%). The above method, wherein said bio-oil has a concentration of acetic acid of less than about 0.5% (e.g., less than about 0.5%). The above method, wherein said bio-oil has a concentration of acetic acid of less than about 0.4% (e.g., less than about 0.4%). The above method, wherein said bio-oil has a concentration of acetic acid of less than about 0.3% (e.g., less than about 0.3%). The above method, wherein said bio-oil has a concentration of acetic acid of less than about 0.2% (e.g., less than about 0.2%). The above method, wherein said bio-oil has a concentration of acetic acid of less than about 0.1% (e.g., less than about 0.1%). The above method, wherein said bio-oil has a concentration of acetic acid of about 0% (e.g., 0%). The above method, wherein said bio-oil has a concentration of levoglucosan of less than about 1% (e.g., less than 1%). The above method, wherein said bio-oil has a concentration of levoglucosan of less than about 0.5% (e.g., less than 0.5%). The above method, wherein said bio-oil has a concentration of levoglucosan of less than about 0.4% (e.g., less than 0.4%). The above method, wherein said bio-oil has a concentration of levoglucosan of less than about 0.3% (e.g., less than 0.3%). The above method, wherein said bio-oil has a concentration of levoglucosan of less than about 0.25% (e.g., less than 0.25%). The above method, wherein said bio-oil has a concentration of levoglucosan of less than about 0.2% (e.g., less than 0.2%). The above method, wherein said bio-oil has a concentration of levoglucosan of less than about 0.15% (e.g., less than 0.15%). The above method, wherein said bio-oil has a concentration of levoglucosan of less than about 0.1% (e.g., less than 0.1%). The above method, wherein said bio-oil has a concentration of levoglucosan of less than about 0.05% (e.g., less than 0.05%). The above method, wherein said bio-oil has a concentration of levoglucosan of about 0% (e.g., 0%). The above method, wherein said bio-oil has a concentration of alkyl phenols of more than about 2% (e.g., more than 2%). The above method, wherein said bio-oil has a concentration of alkyl phenols of more than about 3% (e.g., more than 3%). The above method, wherein said bio-oil has a concentration of alkyl phenols of more than about 4% (e.g., more than 4%). The above method, wherein said bio-oil has a concentration of alkyl phenols of more than about 5% (e.g., more than 5%). The above method, wherein said bio-oil has a concentration of alkyl phenols of more than about 6% (e.g., more than 6%). The above method, wherein said bio-oil has a concentration of alkyl phenols of more than about 7% (e.g., more than 7%). The above method, wherein said bio-oil has a concentration of alkyl phenols of more than about 8% (e.g., more than 8%). The above method, wherein said bio-oil has a concentration of alkyl phenols of more than about 9% (e.g., more than 9%). The above method, wherein said bio-oil has a concentration of alkyl phenols of more than about 10% (e.g., more than 10%). The above method, wherein said bio-oil has a concentration of alkyl phenols of more than about 11% (e.g., more than 11%). The above method, wherein said bio-oil has a concentration of alkyl phenols of more than about 12% (e.g., more than 12%). The above method, wherein said bio-oil has a concentration of alkyl phenols of more than about 13% (e.g., more than 13%). The above method, wherein said bio-oil has a concentration of alkyl phenols of more than about 14% (e.g., more than 14%). The above method, wherein said bio-oil has a concentration of alkyl phenols of about 15% (e.g., 15%). The above method, wherein said bio-oil has a HHV of more than about 30 MJ/kg (e.g., more than 30 MJ/kg). The above method, wherein said bio-oil has a HHV of more than about 35 MJ/kg (e.g., more than 35 MJ/kg). The above method, wherein said bio-oil has a HHV of more than about 36 MJ/kg (e.g., more than 36 MJ/kg). The above method, wherein said bio-oil has a HHV of more than about 37 MJ/kg (e.g., more than 37 MJ/kg). The above method, wherein said bio-oil has a HHV of more than about 38 MJ/kg (e.g., more than 38 MJ/kg). The above method, wherein said bio-oil has a HHV of more than about 39 MJ/kg (e.g., more than 39 MJ/kg). The above method, wherein said bio-oil has a HHV of more than about 40 MJ/kg (e.g., more than 40 MJ/kg). The above method, wherein said bio-oil has a HHV of more than about 41 MJ/kg (e.g., more than 41 MJ/kg). The above method, wherein said bio-oil has a HHV of about 42 MJ/kg (e.g. 42 MJ/kg). The above method, wherein said bio-oil has a viscosity of less than about 20 cP, 60° C. (e.g., less than 20 cP, 60° C.). The above method, wherein said bio-oil has a viscosity of about 4 to about 12 cP, 60° C. (e.g., 4 to 12 cP, 60° C.). The above method, wherein said bio-oil has a viscosity of less than about 50 cP, 40° C. (e.g., less than 50 cP, 40° C.). The above method, wherein said bio-oil has a viscosity of about 8 to about 42 cP, 40° C. (e.g., 8 to 42 cP, 40° C.).

The above method, wherein said feedstock is guayule leaves. The above method, wherein said bio-oil has oxygen content of less than about 23% (e.g., less than 23%). The above method, wherein said bio-oil has oxygen content of less than about 20% (e.g., less than 20%). The above method, wherein said bio-oil has oxygen content of about 15% (e.g., 15%). The above method, wherein said bio-oil has C/O ratio of more than about 3.8 (e.g., more than 3.8). The above method, wherein said bio-oil has C/O ratio of more than about 4 (e.g., more than 4). The above method, wherein said bio-oil has C/O ratio of about 4.5 (e.g., 4.5). The above method, wherein said bio-oil has H/C ratio of more than about 1.1 (e.g., more than 1.1). The above method, wherein said bio-oil has H/C ratio of more than about 1.2 (e.g., more than 1.2). The above method, wherein said bio-oil has H/C ratio of about 1.5 (e.g., 1.5). The above method, wherein said bio-oil has TAN of less than about 29 (e.g., less than 29). The above method, wherein said bio-oil has TAN of less than about 25 (e.g., less than 25). The above method, wherein said bio-oil has TAN of about 20 (e.g., 20). The above method, wherein said bio-oil has a concentration of benzene, toluene, ethyl benzene, p-xylene, and o-xylene of more than about 0.8% (e.g., more than 0.8%). The above method, wherein said bio-oil has a concentration of benzene, toluene, ethyl benzene, p-xylene, and o-xylene of more than about 1% (e.g., more than 1%). The above method, wherein said bio-oil has a concentration of benzene, toluene, ethyl benzene, p-xylene, and o-xylene of about 1.5% (e.g., 1.5%). The above method, wherein said bio-oil has a concentration of alkyl phenols of more than about 2.7% (e.g., more than 2.7%). The above method, wherein said bio-oil has a concentration of alkyl phenols of more than about 3% (e.g., more than 3%). The above method, wherein said bio-oil has a concentration of alkyl phenols of about 3.5% (e.g., more than 3.5%). The above method, wherein said bio-oil has HHV of more than about 27 MJ/kg (e.g., more than 27 MJ/kg). The above method, wherein said bio-oil has HHV of more than about 30 MJ/kg (e.g., more than 30 MJ/kg). The above method, wherein said bio-oil has HHV of about 35 MJ/kg (e.g., 35 MJ/kg). The above method, wherein said bio-oil has a viscosity of less than about 25 cP, 60° C. (e.g., less than 25 cP, 60° C.). The above method, wherein said bio-oil has a viscosity of less than about 20 cP, 60° C. (e.g., 20 cP, 60° C.). The above method, wherein said bio-oil has a viscosity of less than about 15 cP, 60° C. (e.g., less than 15 cP, 60° C.). The above method, wherein said bio-oil has a viscosity of about 10 cP, 60° C. (e.g., 10 cP, 60° C.). The above method, wherein said bio-oil has a viscosity of less than about 70 cP, 40° C. (e.g., less than 70 cP, 40° C.). The above method, wherein said bio-oil has a viscosity of less than about 60 cP, 40° C. (e.g., less than 60 cP, 40° C.). The above method, wherein said bio-oil has a viscosity of about 56 cP, 40° C. (e.g., 56 cP, 40° C.).

A bio-oil produced by the above method.

The above method, further comprising (or consisting essentially of or consisting of) (a) first distilling said bio-oil to produce distillates and then reacting said distillates in a hydrodeoxygenation reactor in a chemically reductive atmosphere [hydrogen environment] to produce hydrocarbons, water, and non-condensable gases or (b) reacting said bio-oil after centrifugation in a hydrodeoxygenation reactor in a chemically reductive atmosphere (e.g., hydrogen environment to produce hydrocarbons, water and non-condensable gases, and then distilling to produce distilled water and distilled hydrocarbons; catalytically hydrogenating and deoxygenating said bio-oil.

The above method, wherein said method utilizes liquid hourly space velocities of at least about 0.4 l/hr. The above method, wherein said process utilizes liquid hourly space velocities of at least about 0.45 l/hr. The above method, wherein said process utilizes liquid hourly space velocities of about 0.5 l/hr (e.g., 0.5 l/hr).

The above method, wherein said reactor utilizes a temperature of about 320° to about 380° C. The above method, wherein said reactor utilizes a temperature of about 350° C.

The above method, wherein said reactor utilizes non-sulfided catalysts. The above method, wherein said reactor utilizes ruthenium, platinum, and/or palladium catalysts on carbon supports. The above method, wherein said reactor utilizes ruthenium catalysts on carbon supports.

The above method, wherein said process utilizes an oil flow rate of about 0.4 to about 0.7 cc oil/cc-catalyst/hr (e.g., 0.4 to 0.7 cc oil/cc-catalyst/hr). The above method, wherein said process utilizes an oil flow rate of about 0.4 to about 0.7 hr⁻¹. (e.g., 0.4 to 0.7 hr⁻¹). The above method, wherein said process utilizes an oil flow rate of more than about 0.4 hr⁻¹.

The above method, wherein said process utilizes a reactor pressure of about 1600 to about 1800 psi (e.g., 1600 to 1800 psi).

The above method, wherein said process utilizes a hydrogen flow rate of about 3000 sccm (e.g., 3000 sccm).

The above method, wherein said process utilizes one reactor.

The above method, wherein said feedstock is guayule bagasse. The above method, wherein said process produces distilled hydrocarbons having HHV of more than about 40 MJ/kg (e.g., more than 40 MJ/kg). The above method, wherein said process produces distilled hydrocarbons having HHV of more than about 41 MJ/kg (e.g., more than 41 MJ/kg). The above method, wherein said process produces distilled hydrocarbons having HHV of more than about 42 MJ/kg (e.g., more than 42 MJ/kg). The above method, wherein said process produces distilled hydrocarbons having HHV of more than about 43 MJ/kg (e.g., more than 43 MJ/kg). The above method, wherein said process produces distilled hydrocarbons having HHV of more than about 44 MJ/kg (e.g., more than 44 MJ/kg). The above method, wherein said process produces distilled hydrocarbons having HHV of about 45 MJ/kg (e.g., 45 MJ/kg). The above method, wherein said process produces distilled hydrocarbons having density of about 0.8 g/mL (e.g., 0.8 g/mL). The above method, wherein said distilled hydrocarbons have O/C ratio of less than about 0.1 (e.g., less than 0.1). The above method, wherein said distilled hydrocarbons have O/C ratio of less than about 0.01 (e.g., less than 0.01). The above method, wherein said distilled hydrocarbons have O/C ratio of less than about 0.001 (e.g., less than 0.001). The above method, wherein said distilled hydrocarbons have O/C ratio of about 0.0001 (e.g., 0.0001). The above method, wherein said distilled hydrocarbons have O/C ratio of about 0 (e.g., 0). The above method, wherein said distilled hydrocarbons have H/C ratio of greater than about 1.5 (e.g., greater than 1.5). The above method, wherein said distilled hydrocarbons have H/C ratio of greater than about 1.6 (e.g., greater than 1.6). The above method, wherein said distilled hydrocarbons have H/C ratio of greater than about 1.65 (e.g., greater than 1.65). The above method, wherein said distilled hydrocarbons have H/C ratio of greater than about 1.7 (e.g., greater than 1.7). The above method, wherein said distilled hydrocarbons have H/C ratio of greater than about 1.75 (e.g., greater than 1.75). The above method, wherein said distilled hydrocarbons have H/C ratio of greater than about 1.8 (e.g., greater than 1.8). The above method, wherein said distilled hydrocarbons have H/C ratio of greater than about 1.85 (e.g., greater than 1.85). The above method, wherein said distilled hydrocarbons have H/C ratio of greater than about 1.9 (e.g., greater than 1.9). The above method, wherein said distilled hydrocarbons have H/C ratio of about 1.92 (e.g., 1.92). The above method, wherein said distilled hydrocarbons have TAN of less than about 20 (e.g., less than 20). The above method, wherein said distilled hydrocarbons have TAN of less than about 15 (e.g., less than 15). The above method, wherein said distilled hydrocarbons have TAN of less than about 10 (e.g., less than 10). The above method, wherein said distilled hydrocarbons have TAN of less than about 9 (e.g., less than 9). The above method, wherein said distilled hydrocarbons have TAN of less than about 8 (e.g., less than 8). The above method, wherein said distilled hydrocarbons have TAN of less than about 7 (e.g., less than 7). The above method, wherein said distilled hydrocarbons have TAN of less than about 6 (e.g., less than 6). The above method, wherein said distilled hydrocarbons have TAN of less than about 5 (e.g., less than 5). The above method, wherein said distilled hydrocarbons have TAN of less than about 4 (e.g., less than 4). The above method, wherein said distilled hydrocarbons have TAN of less than about 3 (e.g., less than 3). The above method, wherein said distilled hydrocarbons have TAN of less than about 2 (e.g., less than 2). The above method, wherein said distilled hydrocarbons have TAN of about 1 (e.g., 1). The above method, wherein said distilled hydrocarbons have density of less than about 9 g/mL (e.g., less than 9 g/ml). The above method, wherein said distilled hydrocarbons have density of less than about 8.6 g/mL (e.g., 8.6 g/mL). The above method, wherein said distilled hydrocarbons have density of about 8 g/mL (e.g., 8 g/ml). The above method, wherein said distilled hydrocarbons have KF of less than about 0.5% (e.g., less than 0.5%). The above method, wherein said distilled hydrocarbons have KF of less than about 0.45% (e.g., less than 0.45%). The above method, wherein said distilled hydrocarbons have KF of about 0.4% (e.g., 0.4%).

The above method, wherein said feedstock is guayule leaves. The above method, wherein said process produces distilled hydrocarbons having HHV of more than about 40 MJ/kg (e.g., more than 40 MJ/kg). The above method, wherein said process produces distilled hydrocarbons having HHV of more than about 41 MJ/kg (e.g., more than 41 MJ/kg). The above method, wherein said process produces distilled hydrocarbons having HHV of more than about 42 MJ/kg (e.g., more than 42 MJ/kg). The above method, wherein said process produces distilled hydrocarbons having HHV of more than about 43 MJ/kg (e.g., more than 43 MJ/kg). The above method, wherein said process produces distilled hydrocarbons having HHV of more than about 44 MJ/kg (e.g., more than 44 MJ/kg). The above method, wherein said process produces distilled hydrocarbons having HHV of more than about 45 MJ/kg (e.g., more than 45 MJ/kg). The above method, wherein said process produces distilled hydrocarbons having HHV of more than about 46 MJ/kg (e.g., more than 46 MJ/kg). The above method, wherein said process produces distilled hydrocarbons having HHV of more than about 47 MJ/kg (e.g., more than 47 MJ/kg). The above method, wherein said process produces distilled hydrocarbons having HHV of more than about 48 MJ/kg (e.g., more than 48 MJ/kg). The above method, wherein said process produces distilled hydrocarbons having HHV of more than about 49 MJ/kg (e.g., more than 49 MJ/kg). The above method, wherein said process produces distilled hydrocarbons having HHV of about 50 MJ/kg (e.g., 50 MJ/kg). The above method, wherein said process produces distilled hydrocarbons having density of about 0.8 g/mL (e.g., 0.8 g/mL). The above method, wherein said distilled hydrocarbons have O/C ratio of less than about 0.1 (e.g., less than 0.1). The above method, wherein said distilled hydrocarbons have O/C ratio of less than about 0.05 (e.g., less than 0.05). The above method, wherein said distilled hydrocarbons have O/C ratio of less than about 0.04 (e.g., less than 0.04). The above method, wherein said distilled hydrocarbons have O/C ratio of about 0.03 (e.g., 0.03). The above method, wherein said distilled hydrocarbons have O/C ratio of about 0 (e.g., 0). The above method, wherein said distilled hydrocarbons have H/C ratio of greater than about 1 (e.g., greater than 1). The above method, wherein said distilled hydrocarbons have H/C ratio of greater than about 1.1 (e.g., greater than 1.1). The above method, wherein said distilled hydrocarbons have H/C ratio of greater than about 1.2 (e.g., greater than 1.2). The above method, wherein said distilled hydrocarbons have H/C ratio of greater than about 1.3 (e.g., greater than 1.3). The above method, wherein said distilled hydrocarbons have H/C ratio of greater than about 1.4 (e.g., greater than 1.4). The above method, wherein said distilled hydrocarbons have H/C ratio of greater than about 1.5 (e.g., greater than 1.5). The above method, wherein said distilled hydrocarbons have H/C ratio of greater than about 1.6 (e.g., greater than 1.6). The above method, wherein said distilled hydrocarbons have H/C ratio of greater than about 1.7 (e.g., greater than 1.7). The above method, wherein said distilled hydrocarbons have H/C ratio of greater than about 1.8 (e.g., greater than 1.8). The above method, wherein said distilled hydrocarbons have H/C ratio of about 1.9 (e.g., 1.9). The above method, wherein said distilled hydrocarbons have TAN of less than about 15 (e.g., less than 15). The above method, wherein said distilled hydrocarbons have TAN of less than about 14 (e.g., less than 14). The above method, wherein said distilled hydrocarbons have TAN of less than about 13 (e.g., less than 13). The above method, wherein said distilled hydrocarbons have TAN of less than about 12 (e.g., less than 12). The above method, wherein said distilled hydrocarbons have TAN of less than about 11 (e.g., less than 11). The above method, wherein said distilled hydrocarbons have TAN of less than about 10 (e.g., less than 10). The above method, wherein said distilled hydrocarbons have TAN of less than about 8 (e.g., less than 8). The above method, wherein said distilled hydrocarbons have TAN of less than about 7 (e.g., less than 7). The above method, wherein said distilled hydrocarbons have TAN of less than about 6 (e.g., less than 6). The above method, wherein said distilled hydrocarbons have TAN of about 5 (e.g., 5). The above method, wherein said distilled hydrocarbons have density of less than about 9 g/mL (e.g., less than 9 g/ml). The above method, wherein said distilled hydrocarbons have density of less than about 8.5 g/mL (e.g., 8.5 g/mL). The above method, wherein said distilled hydrocarbons have density of less than about 8.4 g/mL (e.g., 8.4 g/mL). The above method, wherein said distilled hydrocarbons have density of less than about 8.3 g/mL (e.g., 8.3 g/mL). The above method, wherein said distilled hydrocarbons have density of less than about 8.2 g/mL (e.g., 8.2 g/mL). The above method, wherein said distilled hydrocarbons have density of less than about 8.1 g/mL (e.g., 8.1 g/mL). The above method, wherein said distilled hydrocarbons have density of about 8 g/mL (e.g., 8 g/ml). The above method, wherein said distilled hydrocarbons have KF of less than about 0.8% (e.g., less than 0.8%). The above method, wherein said distilled hydrocarbons have KF of less than about 0.75% (e.g., less than 0.75%). The above method, wherein said distilled hydrocarbons have KF of less than about 0.7% (e.g., less than 0.7%). The above method, wherein said distilled hydrocarbons have KF of less than about 0.65% (e.g., less than 0.65%). The above method, wherein said distilled hydrocarbons have KF of less than about 0.6% (e.g., less than 0.6%). The above method, wherein said distilled hydrocarbons have KF of less than about 0.55% (e.g., less than 0.55%). The above method, wherein said distilled hydrocarbons have KF of less than about 0.5% (e.g., less than 0.5%). The above method, wherein said distilled hydrocarbons have KF of less than about 0.35% (e.g., less than 0.35%). The above method, wherein said distilled hydrocarbons have KF of less than about 0.3% (e.g., less than 0.3%). The above method, wherein said distilled hydrocarbons have KF of less than about 0.25% (e.g., less than 0.25%). The above method, wherein said distilled hydrocarbons have KF of about 0.2% (e.g., 0.2%).

A HDO bio-oil produced by the method according to claim 77.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Analysis of guayule bagasse

| Feedstock Elemental Analysis | | | |
|---|---|---|---|
| (wt %) | As Is | Dry Basis | Dry Ash Free |
| moisture | 5.69 | | |
| H | 5.78 | 6.18 | 6.58 |
| C | 50.31 | 53.77 | 57.25 |
| N | 1.11 | 1.18 | 1.26 |
| O | 31.78 | 33.97 | 36.17 |
| Ash | 5.69 | 6.08 | |
| HHV (MJ/kg) | 19.83 | 21.03 | 22.39 |
| C/O (mol) | 2.11 | | |
| O/C (mol) | 0.47 | | |
| H/C (mol) | 1.38 | | |

TABLE 2
Product Yields (Model Corrected), [wt %]

| | Conventional | | TGRP | | |
|---|---|---|---|---|---|
| Product | SWG | Guayule | SWG | Guayule | Guayule |
| Distribution | [9] | [7] | [8, 9] | (45-65%) | (70-85%) |
| Total Liquids | 64.1 | 64.8 | 56.5 | 57.2 (3.60) | 52.3 (5.30) |
| Organic Bio-oil | 49.3 | 49.0 | 33.3 | 40.0 (1.94) | 33.9 (1.99) |
| Water | 14.8 | 15.8 | 22.2 | 17.1 (1.99) | 18.4 (3.59) |
| Bio-char | 23.8 | 17.9 | 13.8 | 25.15 (4.04) | 22.0 (4.79) |
| Non condensable | 22.2 | 17.0 | 33.6 | 18.7 (5.19) | 26.0 (3.29) |
| gases | | | | | |

*Current data: Average of 2 runs with recycle rate ranging from 45-65% N₂ replacement and average of 3 runs with recycle rate ranging from 70-85%. The standard deviation from the averages is in parenthesis.
SWG = switchgrass.
[7] = Boateng, A. A., et al., Fuel, 88: 2207-2215 (2009).
[8] = U.S. patent application Ser. No. 13/777,020, filed 26 Feb. 2013.
[9] = Mullen, C. A., et al., Energy and Fuels, 27: 3867-3874 (2013).

TABLE 3
Comparison of the analysis of pyrolysis oils from Guayule Bagasse
with Switchgrass (SWG) for Conventional Pyrolysis and TGRP

| | Conventional | | TGRP | | |
|---|---|---|---|---|---|
| | SWG | Guayule | SWG | Guayule | Guayule |
| | [9] | [7] | [8, 9] | (45-60%) | (70-85%) |
| C (wt %, db) | 59.82 | 69.97 | 80.29 | 71.91 (1.91) | 81.41 (3.10) |
| H (wt %, db) | 6.03 | 7.96 | 5.67 | 7.23 (0.22) | 8.32 (0.43) |
| N (wt %, db) | 0.92 | 0.82 | 1.50 | 1.88 (0.41) | 2.14 (0.48) |
| O (wt %, db) | 33.32 | 21.38 | 12.54 | 18.99 (1.71) | 8.27 (3.00) |
| C/O (mol) | 1.97 | 4.35 | 8.53 | 4.89 (0.96) | 14.31 (5.04) |
| H/C (mol) | 1.21 | 1.37 | 0.84 | 1.21 (0.004) | 1.23 (0.10) |
| *HHV | 23.4 | 31.7 | 33.2 | 31.6 (1.19) | 37.5 (1.09) |
| (MJ/kg, db) | | | | | |
| *TAN (mg | 119 | NM | 24 | 30 (3.7) | 16.6 (10.0) |
| KOH/g) | | | | | |

| | | | | |
|---|---|---|---|---|
| Viscosity | NM | 448.3 | NM | 4-12** |
| (cp, 60° C.) | | | | |
| Viscosity | NM | NM*** | NM | 8-32** |
| (cp, 40° C.) | | | | |

*HHV = Higher Heating Value, Gasoline ~44 MJ/kg. TAN = Total Acid Number.
NM = Not measured.
**= average for Guayule (45-60%) and Guayule (70-85%).
***= too viscous to measure

TABLE 4
Quantification of Selected Compounds found in pyrolysis oil by
GC/MS. Guayule-(45-60%) (average of 2 runs 45-60% recycle rate);
Guayule-(75-80%) (average of 3 runs 75-80% recycle rate).

| | | | TGRP | | |
|---|---|---|---|---|---|
| | Conventional | | | Guayule | Guayule |
| | SWG | Guayule | SWG | (45-60%) | (70-85%) |
| Alkyl Benzenes | | | | | |
| Benzene | 0.05 | detected | 2.47 | 0.15 | 0.73 |
| Toluene | 0.04 | detected | 0.97 | 0.90 | 2.94 |
| Ethyl Benzene | 0.02 | detected | 0.09 | 0.13 | 0.34 |
| p-xylene | 0.02 | detected | 0.27 | 0.72 | 2.27 |
| o-xylene | 0.02 | detected | 0.14 | 0.19 | 0.59 |
| BTEX | 0.15 | detected | 3.94 | 2.09 | 6.87 |
| Polycyclic aromatic HCs | | | | | |
| Naphthalene | nd | detected | 4.36 | 0.15 | 0.71 |
| 2-methyl naphthalene | nd | detected | 1.00 | 0.15 | 0.57 |
| Indene | 0.08 | Detected | 2.99 | 0.26 | 0.94 |
| Biphenyl | 0.01 | nd | 0.38 | 0.02 | 0.07 |
| Fluorene | 0.02 | nd | 0.37 | 0.02 | 0.08 |
| Anthracene | nd | nd | 0.55 | 0.01 | 0.04 |
| TOTAL 11 aromatic HCs | 0.26 | — | 13.59 | 2.70 | 9.28 |
| Alkyl Phenols | | | | | |
| phenol | 0.47 | 0.65 | 3.75 | 1.08 | 2.61 |
| o-cresol | 0.19 | 0.21 | 0.64 | 0.38 | 1.02 |
| p-cresol | 0.22 | 0.19 | 0.96 | 0.24 | 0.85 |
| m-cresol | 0.18 | 0.27 | 0.91 | 0.47 | 1.30 |
| 2,4-dimethylphenol | 0.11 | 0.13 | 0.34 | 0.21 | 0.63 |
| 4-ethyl phenol | 0.34 | 0.11 | 0.29 | 0.10 | 0.26 |
| TOTAL ALKYL PHENOLS | 1.51 | 1.56 | 6.89 | 2.48 | 6.68 |
| Guaiacols | | | | | |
| guaiacol | 0.46 | 0.39 | nd | 0.10 | 0.04 |
| 2-methoxy-4-methylphenol | trace | 0.15 | nd | 0.05 | trace |
| vanillin | trace | nd | trace | 0.00 | nd |
| 4-hydroxy-3- | nd | nd | nd | 0.02 | nd |
| methoxyphenylacetone | | | | | |
| Syringols | | | | | |
| 2,6-dimethoxyphenol | 0.38 | detected | nd | 0.12 | trace |
| 3′,5′-dimethoxyacetophenone | nd | nd | nd | nd | nd |
| Furans | | | | | |
| furfural | 0.18 | nd | nd | nd | nd |
| furfuryl alcohol | trace | 0.09 | trace | nd | 0.01 |
| 2(5H)-furanone | 0.1 | nd | 0.03 | nd | 0.01 |
| 5-hydroxymethyl-2-furaldehyde | 0.07 | nd | nd | nd | nd |
| Small Oxygenates | | | | | |
| Acetic Acid | 6.40 | 1.29 | 0.27 | 0.33 | nd |
| Acetol | 5.60 | 0.73 | nd | 0.32 | 0.04 |
| Cyclopentanones | | | | | |
| 2-methyl cyclopentanone | trace | detected | Trace | nd | 0.10 |
| 2-methyl-2-cylopenten-1-one | 0.04 | 0.06 | 0.90 | 0.90 | 1.53 |
| 2,3-dimethyl-2-cyclopenten-l-one | 0.03 | detected | 0.05 | 0.15 | 0.35 |
| 3-methyl-1,2-cyclopentandione | 0.11 | nd | nd | 0.03 | nd |
| Levolglucosan | 4.65 | 1.37 | nd | 0.02 | trace |

nd = not detected.
Detected = detected but not quantified.
Trace means ≦0.02 wt %

TABLE 5
Composition of aqueous phase produced from pyrolysis processes

| | | TGRP | | |
|---|---|---|---|---|
| | Conventional^{a} | | Guayule | Guayule |
| | SWG | SWG | (45-60%) | (70-85%) |
| Water (wt %) | 27.0 | 93.7 | 82.80 | 84.36 |
| Acetic Acid (wt %, db) | 12.3 | 46.0 | 10.688 | 11.247 |
| Acetol (wt %, db) | 16.5 | 1.5 | 2.764 | 7.783 |
| Levoglucosan (wt %, db) | 2.7 | — | 0.005 | 0.507 |
| Phenol (wt %, db) | 0.33 | 3.6 | 0.972 | 1.612 |
| Cresols (wt %, db) | 0.62 | 0.42 | 0.727 | 0.932 |

^{a}Conventional pyrolysis of guayule bagasse did not produce a separate aqueous phase

TABLE 6
Characterization of centrifuged guayule TGRP bio-oil,
before and after HDO over three different catalysts.

| | centrifuged | | | |
|---|---|---|---|---|
| | oil | Pt/C | Ru/C | Pd/C |
| Voil (ml/min) | | 0.5 | 0.6 | 0.6 |
| H2 flow (sccm) | | 3000 | 3000 | 3000 |
| P (psi) | | 1738 | 1900 | 1880 |
| LHSV(1/hr) | | 0.46 | 0.55 | 0.61 |
| % yield* | | 49 | 58 | 51 |
| Density (g/mL) | 1.04 | 0.852 | 0.83 | 0.83 |
| KF (wt %) | 11.27 | 0.48 | 0.08 | 0.3 |
| TAN (mg KOH/g) | 32.00 | 9.51** | 3.32** | 12.1 |
| HHV (MJ/kg) | 31.7 | 41.1 | 43.3 | 43.8 |
| wt % O (dry) | 12.56 | 4.01 | 3.03 | 4.14 |
| H/C (mol) | 1.487 | 1.762 | 1.727 | 1.74 |
| O/C (mol) | 0.124 | 0.036 | 0.027 | 0.038 |
| GC-MS (wt %) | | | | |
| Acetic Acid | 0 | 0 | 0 | 0 |
| Acetol | 0 | 0 | 0 | 0 |
| Phenols | 6.12 | 7.47 | 3.1 | 1.64 |
| Naphthenes | 0.11 | 5.69 | 6.87 | 4.98 |
| Paraffins | 0.06 | 3.62 | 5.0 | 2.72 |
| Aromatic | 6.72 | 11.17 | 10.84 | 6.73 |
| Hydrocarbons | | | | |

*based on mass
**Reported R2 value for TAN

TABLE 7
Distillation of products from Ru-catalyzed HDO of guayule TGRP bio-oil.

| | Fraction | | | | | |
|---|---|---|---|---|---|---|
| | 1 | 2 | 3 | 4 | 5 | 6 |
| Density | 0.730 | 0.780 | 0.840 | 0.870 | 0.880 | 0.860 |
| HHV | 43.2 | 44.4 | 44.0 | 41.1 | 44.1 | 45.0* |
| KF (wt %) | 0.00 | 0.00 | 0.24 | 0.13 | 0.07 | 0.15 |
| % Distilled | 13.9 | 16.5 | 20.1 | 17.0 | 18.4 | 5.6 |
| Tₒᵥ (° C.) | 30-80 | 80-105 | 105-130 | 130-155 | 155-160 | 160-260 |
| | | | | | | (170 + vac) |
| wt % (dry) | | | | | | |
| N | 0.14 | 0.11 | 0.11 | 0.10 | 0.07 | 0.07 |
| C | 83.95 | 85.55 | 84.56 | 85.27 | 85.89 | 85.71 |
| H | 13.42 | 12.48 | 11.47 | 10.59 | 11.49 | 12.11 |
| O | 2.49 | 1.86 | 3.86 | 4.03 | 2.55 | 2.11 |
| H:C (mol) | 1.918 | 1.750 | 1.627 | 1.487 | 1.605 | 1.695 |
| O:C (mol) | 0.022 | 0.016 | 0.034 | 0.036 | 0.022 | 0.019 |
| GC-MS wt % | | | | | | |
| Acetic Acid | 0 | 0 | 0 | 0 | 0 | 0 |
| Phenols | 0.05 | 0.53 | 1.71 | 2.77 | 0.05 | 0.06 |
| Naphthenes | 17.85 | 19.39 | 13.71 | 5.44 | 0.14 | 0.01 |
| Paraffins | 14.18 | 5.15 | 2.5 | 3.39 | >5.25 | >2.75 |
| Aromatic Hydrocarbons | 13.29 | 28.49 | 24.62 | 5.58 | 2.0 | 0.28 |
| Octane number (est) | 83.50 | 92.48 | 90.09 | | | |
| Cetane number (est) | | | 63.5 | 84.3 | 95.33 | 106.67 |

TABLE 8
Characterization of distilled guayule TGRP bio-oil, before and
after HDO over two different catalysts and two flow rates

| | distilled | | | | |
|---|---|---|---|---|---|
| | oil | Pt/C | Pt/C | Ru/C | Ru/C |
| Voil (ml/min) | | 0.5 | 0.75 | 0.45 | 0.64 |
| H2 flow (sccm) | | 3000 | 3000 | 3000 | 3000 |
| P (psi) | | 1830 | 1830 | 1880 | 1880 |
| LHSV(1/hr) | | 0.46 | 0.69 | 0.46 | 0.66 |
| % yield* | | 84 | 79 | 63 | 60 |
| Density (g/mL) | 0.94 | 0.849 | 0.858 | 0.81 | 0.81 |
| KF (wt %) | 1.12 | 0.35 | 0.44 | 0.23 | 0.22 |
| TAN (mg KOH/g) | 31.6 | 5.90* | 7.5 | 20** | 14.2** |
| HHV (MJ/kg) | 38.2 | 41.3 | 41.4 | 43.4 | 42.9 |
| wt % O (dry) | 10.42 | 4.78 | 5.79 | 0.66 | 0.21 |
| H/C (mol) | 1.37 | 1.70 | 1.681 | 1.73 | 1.71 |
| O/C (mol) | 0.098 | 0.043 | 0.053 | 0.004 | 0.0001 |
| GC-MS (wt %) | | | | | |
| Acetic Acid | 0.66 | 0 | 0 | 0 | 0 |
| Acetol | 0.25 | 0 | 0 | 0 | 0 |
| Phenols | 7.88 | 7.85 | 9.84 | 0.67 | 1.77 |
| Naphthenes | 0.13 | 11.39 | 8.08 | 7.93 | 6.9 |
| Paraffins | 0.05 | 6.74 | 5.485 | 3.06 | 2.75 |
| Aromatics | 12.09 | 22.08 | 23.57 | 17.64 | 17.07 |

*based on mass
**Reported R2 value for TAN

TABLE 9

| ASTM | | |
|---|---|---|
| method | specification | value |
| D-6304 | Karl Fischer Moisture (ppm) | 2216 |
| D-664 | TAN (mg/g KOH) | 1.08 |
| D-4052 | API gravity (° API) | 33.8 |
| D-4052 | Density (g/mL) | 0.8553 |
| D-130 | copper strip corrosion | 2C |
| D-2622 | sulfur (ppm) | 335 |
| D-4737 | cetane number | 21.6 |

TABLE 10
Analysis of guayule leaves

| Feedstock Elemental Analysis | | | |
|---|---|---|---|
| (wt %) | As Is | Dry Basis | Dry Ash Free |
| Moisture | 2.84 | | |
| H | 6.21 | 6.39 | 7.58 |
| C | 43.18 | 44.44 | 52.95 |
| N | 2.14 | 2.20 | 2.63 |
| O | 30.10 | 30.98 | 36.92 |
| Ash | 16.55 | 16.08 | |
| HHV (MJ/kg) | | | |
| C/O (mol) | 1.91 | | |
| O/C (mol) | 0.52 | | |
| H/C (mol) | 1.73 | | |

TABLE 11
Product Yields (Model Corrected), [wt %]

| | | TGRP | | | |
|---|---|---|---|---|---|
| | | | Guayule | Guayule | Guayule |
| Product | Conventional | | Leaves | Leaves | Leaves Avg. |
| Distribution | SWG | SWG | (72) | (48) | (48-75) |
| Total Liquids | 64.1 | 56.5 | 45.7 | 42.4 | 44.1 |
| Organic Bio-oil | 49.3 | 33.3 | 30.4 | 28.9 | 29.7 |
| Water | 14.8 | 22.2 | 14.7 | 13.5 | 14.1 |
| Bio-char | 23.8 | 13.8 | 31.0 | 35.6 | 33.3 |
| Non condensable gases | 22.2 | 33.6 | 21.0 | 22.0 | 21.5 |

Numbers in bold are % recycled gas in reaction atmosphere

TABLE 12
Comparison of the analysis of pyrolysis oils
from the TGRP of Guayule Leaves with TGRP and
conventional pyrolysis of Switchgrass (SWG).

| | | TGRP | | | |
|---|---|---|---|---|---|
| | | | Guayule | Guayule | Guayule |
| | Conventional | | Leaves | Leaves | Leaves Avg. |
| | SWG | SWG | (72) | (48) | (48-72) |
| C (wt %, db) | 59.82 | 80.29 | 69.50 | 66.80 | 68.15 |
| H (wt %, db) | 6.03 | 5.67 | 7.13 | 6.33 | 6.73 |
| N (wt %, db) | 0.92 | 1.50 | 3.50 | 3.76 | 3.63 |
| O (wt %, db) | 33.32 | 12.54 | 19.82 | 22.95 | 21.39 |
| C/O (mol) | 1.97 | 8.53 | 4.70 | 3.88 | 4.29 |
| H/C (mol) | 1.21 | 0.84 | 1.23 | 1.14 | 1.19 |
| *HHV | 23.4 | 33.2 | 30.5 | 27.9 | 29.2 |
| (MJ/kg, db) | | | | | |
| *TAN | 119 | 24 | 16.6 | 28.3 | 22.5 |
| (mg KOH/g) | | | | | |
| Viscosity | | NM | — | — | 15 |
| (cP, 60° C.) | | | | | |
| Viscosity | | NM | — | — | 56 |
| (cP, 40° C.) | | | | | |

*HHV = Higher Heating Value, Gasoline ~44 MJ/kg. TAN = Total Acid Number,
NM = Not measured.
Numbers in bold are % recycled gas in reaction atmosphere

TABLE 13
Quantification of Selected Compounds found in pyrolysis oil by GC/MS.

| | | TGRP | | | |
|---|---|---|---|---|---|
| | | | Guayule | Guayule | G. |
| | Conventional | | Leaves | Leaves | Leaves Avg. |
| | SWG | SWG | (72) | (48) | (48-72) |
| Alkyl Benzenes | | | | | |
| Benzene | 0.05 | 2.47 | 0.07 | trace | 0.035 |
| Toluene | 0.04 | 0.97 | 0.71 | 0.41 | 0.56 |
| Ethyl Benzene | 0.02 | 0.09 | 0.14 | 0.35 | 0.25 |
| p-xylene | 0.02 | 0.27 | trace | trace | trace |
| o-xylene | 0.02 | 0.14 | trace | trace | trace |
| BTEX | 0.15 | 3.94 | 0.93 | 0.80 | 0.865 |
| Polycyclic aromatic HCs | | | | | |
| naphthalene | nd | 4.36 | 0.34 | trace | 0.17 |
| 2-methyl naphthalene | nd | 1.00 | trace | trace | trace |
| Indene | 0.08 | 2.99 | 0.36 | 0.19 | 0.275 |
| Biphenyl | 0.01 | 0.38 | 0.07 | 0.03 | 0.05 |
| Fluorene | 0.02 | 0.37 | trace | trace | trace |
| Anthracene | nd | 0.55 | 0.11 | trace | 0.055 |
| TOTAL 11 aromatic HCs | 0.26 | 13.59 | 1.47 | 1.23 | 1.35 |
| Alkyl Phenols | | | | | |
| phenol | 0.47 | 3.75 | 1.39 | 1.63 | 1.51 |
| o-cresol | 0.19 | 0.64 | 0.42 | 0.43 | 0.425 |
| p-cresol | 0.22 | 0.96 | 0.54 | 0.58 | 0.56 |
| m-cresol | 0.18 | 0.91 | 0.35 | trace | 0.175 |
| 2,4-dimethylphenol | 0.11 | 0.34 | 0.06 | 0.07 | 0.065 |
| 4-ethyl phenol | 0.34 | 0.29 | 0.06 | 0.06 | 0.06 |
| TOTAL ALKYL PHENOLS | 1.51 | 6.89 | 2.82 | 2.77 | 2.795 |
| Guaiacols | | | | | |
| guaiacol | 0.46 | nd | nd | nd | nd |
| 2-methoxy-4-methylphenol | trace | nd | nd | nd | nd |
| vanillin | trace | trace | nd | nd | nd |
| 4-hydroxy-3- | nd | nd | trace | trace | 0 |
| methoxyphenylacetone | | | | | |
| Syringols | | | | | |
| 2,6-dimethoxyphenol | 0.38 | nd | nd | nd | nd |
| 3′,5′-dimethoxyacetophenone | nd | nd | trace | nd | trace |
| Furans | | | | | |
| furfural | 0.18 | nd | nd | nd | nd |
| furfuryl alcohol | trace | trace | nd | nd | nd |
| 2(5H)-furanone | 0.1 | 0.03 | trace | trace | trace |
| 5-hydroxymethyl-2- | 0.07 | nd | nd | nd | nd |
| furaldehyde | | | | | |
| Small Oxygenates | | | | | |
| Acetic Acid | 6.40 | 0.27 | nd | nd | nd |
| Acetol | 5.60 | nd | trace | trace | trace |
| Cyclopentanones | | | | | |
| 2-methyl cyclopentanone | trace | trace | trace | trace | trace |
| 2-methyl-2-cylopenten-1-one | 0.04 | 0.90 | 0.32 | trace | 0.16 |
| 2,3-dimethyl-2-cyclopenten- | 0.03 | 0.05 | 0.07 | 0.14 | 0.105 |
| 1-one | | | | | |
| 3-methyl-1,2- | 0.11 | nd | nd | trace | Nd |
| cyclopentandione | | | | | |
| Levoglucosan | 4.65 | nd | nd | nd | Nd |

nd = not detected.
Detected = detected but not quantified.
Trace means ≦0.02 wt %.
Numbers in bold are % recycled gas in reaction atmosphere

TABLE 14
Composition of aqueous phase produced from pyrolysis processes

| | | TGRP | | | |
|---|---|---|---|---|---|
| | | | Guayule | Guayule | Guayule |
| | Conventional | | Leaves | Leaves | Leaves Avg |
| | SWG | SWG | (72) | (48) | (48-72) |
| Water (wt %) | 27.0 | 93.7 | 83.0 | 82.8 | 82.9 |
| Acetic Acid (wt %, db) | 12.3 | 46.0 | 0.50 | 0.55 | 0.53 |
| Acetol (wt %, db) | 16.5 | 1.5 | trace | trace | Trace |
| Levoglucosan (wt %, | 2.7 | — | trace | trace | Trace |
| db) | | | | | |
| Phenol (wt %, db) | 0.33 | 3.6 | 0.26 | 0.19 | 0.23 |
| Cresols (wt %, db) | 0.62 | 0.42 | 0.06 | trace | 0.03 |

Numbers in bold are % recycled gas in reaction atmosphere.
Trace means ≦0.02 wt %.

TABLE 15
Characterization and yields of guayule leaves bio-oil distillate fractions

| | Fraction | | | | | |
|---|---|---|---|---|---|---|
| | 1 | 2 | 3 | 4 | 5 | 6 |
| Density | 0.850 | 0.897 | 0.921 | 0.945 | 0.976 | 1.002 |
| (g/mL) | | | | | | |
| KF (wt %) | 1.04 | 0.84 | 1.03 | 1.61 | 1.22 | 1.31 |
| % of | 7.6 | 6.3 | 10.7 | 16.1 | 11.8 | 9.0 |
| bio-oil | | | | | | |
| Tₒᵥ (° C.) | 54-74 | 74-98 | 98-167 | 167-196 | 196-228 | 228-282 |
| | | | | | | (197 + vac) |
| wt % (dry) | | | | | | |
| N | 2.68 | 2.83 | 2.12 | 2.91 | 4.09 | 4.19 |
| C | 80.41 | 79.35 | 79.54 | 79.06 | 77.60 | 76.10 |
| H | 9.54 | 9.16 | 8.99 | 8.85 | 8.60 | 7.71 |
| O | 7.37 | 8.67 | 9.34 | 9.18 | 9.71 | 12.00 |
| H:C (mol) | 1.424 | 1.385 | 1.357 | 1.343 | 1.331 | 1.216 |
| O:C (mol) | 0.069 | 0.082 | 0.088 | 0.087 | 0.094 | 0.118 |

TABLE 16
Characterization of centrifuged guayule-
based bio-oils, before and after HDO.

| | centrifuged | centrifuged | | |
|---|---|---|---|---|
| | oil | oil | Pd/C | Pd/C |
| | (bagasse) | (leaves) | (bagasse) | (leaves) |
| Vₒᵢₗ (ml/min) | | | 0.6 | 0.6 |
| H₂ flow (sccm) | | | 3000 | 3000 |
| P (psi) | | | 1880 | 1800 |
| LHSV(1/hr) | | | 0.61 | 0.55 |
| % yield | 1.04 | <1.0 | 51 | 50.4 |
| Density (g/mL) | | | 0.83 | 0.82 |
| KF (wt %) | 11.27 | 1.76 | 0.3 | 0.74 |
| TAN (mg KOH/g) | 32.00 | 7.7 | 12.1 | 8.6 |
| HHV (MJ/kg) | 31.7 | 36.8 | 43.8 | 40.7 |
| wt % O (dry) | 12.56 | 20.3 | 4.14 | 2.84 |
| H/C (mol) | 1.487 | 1.11 | 1.74 | 1.70 |
| O/C (mol) | 0.124 | 0.218 | 0.038 | 0.025 |

TABLE 17
Composition of Non Condensable Gases

| | | | TGRP | | |
|---|---|---|---|---|---|
| | Conventional | | | Guayule | Guayule |
| | SWG | Guayule | SWG | (45-60) | (70-85) |
| CO | 57.6 | 49 | 54.6 | 28.0 | 31.3 |
| CO₂ | 29.5 | 25 | 15.7 | 45.8 | 32.3 |
| H₂ | 5.1 | 11 | 12.0 | 8.3 | 12.2 |
| CH₄ | 7.8 | 15 | 15.6 | 13.8 | 17.3 |
| C₂H₄ | nm | nm | Nm | 0.6 | 3.36 |
| C₂H₆ | 0 | 0 | 1.1 | 1.8 | 1.8 |
| C₃H₈ | 0 | 0 | 0.8 | 1.7 | 1.6 |

We claim:

1. A method for producing bio-oil from a feedstock, said method comprising (1) pyrolyzing said feedstock in an inert atmosphere in a reactor to produce bio-oil, bio-char, and non-condensable gases; (2) recycling about 10 to about 99% of said non-condensable gases to said reactor to produce deoxygenated bio-oil; wherein said method is conducted in the absence of oxygen and wherein said method does not utilize externally added catalysts; wherein said feedstock is selected from the group consisting of guayule bagasse, guayule leaves, and mixtures thereof.

2. The method according to claim 1, wherein said method is conducted at a temperature of about 400° to about 600° C.

3. The method according to claim 1, wherein said method is conducted at a temperature of about 450° to about 575° C.

4. The method according to claim 1, wherein said method is conducted at a temperature of about 475° to about 550° C.

5. The method according to claim 1, wherein said method comprises recycling about 60 to about 90% of said non-condensable gases to said reactor to produce deoxygenated bio-oil.

6. The method according to claim 1, wherein said method comprises recycling about 65 to about 85% of said non-condensable gases to said reactor to produce deoxygenated bio-oil.

7. The method according to claim 1, wherein said method comprises recycling about 70 to about 85% of said non-condensable gases to said reactor to produce deoxygenated bio-oil.

8. The method according to claim 1, wherein said feedstock is guayule bagasse.

9. The method according to claim 8, wherein said method produces non-condensable gases containing about 13 to about 17% of the energy in said feedstock.

10. The method according to claim 8, wherein said method produces non-condensable gases containing about 15% of the energy in said feedstock.

11. The method according to claim 8, wherein said bio-oil contains about 55 to about 60% of the energy in said feedstock.

12. The method according to claim 8, wherein said bio-oil contains about 57% of the energy in said feedstock.

13. The method according to claim 8, wherein said bio-oil has oxygen content of less than about 30 wt %.

14. The method according to claim 8, wherein said bio-oil has oxygen content of less than about 20 wt %.

15. The method according to claim 8, wherein said bio-oil has oxygen content of less than about 10 wt %.

16. The method according to claim 8, wherein said bio-oil has oxygen content of less than about 9 wt %.

17. The method according to claim 8, wherein said bio-oil has oxygen content of less than about 5 wt %.

18. The method according to claim 8, wherein said bio-oil has oxygen content of less than about 1 wt %.

19. The method according to claim 8, wherein said bio-oil has oxygen content is about 0 wt %.

20. The method according to claim 8, wherein said bio-oil has C/O ratio of greater than about 3.

21. The method according to claim 8, wherein said bio-oil has C/O ratio of greater than about 10.

22. The method according to claim 8, wherein said bio-oil has C/O ratio of greater than about 12.

23. The method according to claim 8, wherein said bio-oil has C/O ratio of greater than about 20.

24. The method according to claim 8, wherein said bio-oil has C/O ratio of greater than about 30.

25. The method according to claim 8, wherein said bio-oil has C/O ratio of about 120.

26. The method according to claim 8, wherein said bio-oil has H/C ratio of greater than about 1.

27. The method according to claim 8, wherein said bio-oil has H/C ratio of greater than about 1.2.

28. The method according to claim 8, wherein said bio-oil has H/C ratio of about 2.

29. The method according to claim 8, wherein said bio-oil has TAN of less than about 80.

30. The method according to claim 8, wherein said bio-oil has TAN of less than about 30.

31. The method according to claim 8, wherein said bio-oil has TAN of less than about 20.

32. The method according to claim 8, wherein said bio-oil has TAN of less than about 17.

33. The method according to claim 8, wherein said bio-oil has TAN of less than about 15.

34. The method according to claim 8, wherein said bio-oil has TAN of about 1.

35. The method according to claim 8, wherein said bio-oil has a concentration of benzene, toluene, ethyl benzene, p-xylene, and o-xylene of more than about 2%.

36. The method according to claim 8, wherein said bio-oil has a concentration of benzene, toluene, ethyl benzene, p-xylene, and o-xylene of more than about 5%.

37. The method according to claim 8, wherein said bio-oil has a concentration of benzene, toluene, ethyl benzene, and xylene of more than about 6%.

38. The method according to claim 8, wherein said bio-oil has a concentration of benzene, toluene, ethyl benzene, p-xylene, and o-xylene of about 20%.

39. The method according to claim 8, wherein said bio-oil has a concentration of benzene of more than about 0.6%.

40. The method according to claim 8, wherein said bio-oil has a concentration of benzene of more than about 0.7%.

41. The method according to claim 8, wherein said bio-oil has a concentration of toluene of more than about 2.5%.

42. The method according to claim 8, wherein said bio-oil has a concentration of toluene of more than about 2.8%.

43. The method according to claim 8, wherein said bio-oil has a concentration of ethyl benzene of more than about 0.25%.

44. The method according to claim 8, wherein said bio-oil has a concentration of ethyl benzene of more than about 0.3%.

45. The method according to claim 8, wherein said bio-oil has a concentration of p-xylene of more than about 2%.

46. The method according to claim 8, wherein said bio-oil has a concentration of p-xylene of more than about 2.2%.

47. The method according to claim 8, wherein said bio-oil has a concentration of o-xylene of more than about 0.4%.

48. The method according to claim 8, wherein said bio-oil has a concentration of o-xylene of more than about 0.5%.

49. The method according to claim 8, wherein said bio-oil has a concentration of acetic acid of less than about 1%.

50. The method according to claim 8, wherein said bio-oil has a concentration of acetic acid of less than about 0.5%.

51. The method according to claim 8, wherein said bio-oil has a concentration of acetic acid of about 0%.

52. The method according to claim 8, wherein said bio-oil has a concentration of levoglucosan of less than about 1%.

53. The method according to claim 8, wherein said bio-oil has a concentration of levoglucosan of less than about 0.5%.

54. The method according to claim 8, wherein said bio-oil has a concentration of levoglucosan of less than about 0.25%.

55. The method according to claim 8, wherein said bio-oil has a concentration of levoglucosan of less than about 0.1%.

56. The method according to claim 8, wherein said bio-oil has a concentration of levoglucosan of about 0%.

57. The method according to claim 8, wherein said bio-oil has a concentration of alkyl phenols of more than about 2%.

58. The method according to claim 8, wherein said bio-oil has a concentration of alkyl phenols of more than about 3%.

59. The method according to claim 8, wherein said bio-oil has a concentration of alkyl phenols of more than about 4%.

60. The method according to claim 8, wherein said bio-oil has a concentration of alkyl phenols of more than about 5%.

61. The method according to claim 8, wherein said bio-oil has a concentration of alkyl phenols of more than about 6%.

62. The method according to claim 8, wherein said bio-oil has a concentration of alkyl phenols of about 15%.

63. The method according to claim 8, wherein said bio-oil has a HHV of more than about 30 MJ/kg.

64. The method according to claim 8, wherein said bio-oil has a HHV of more than about 35 MJ/kg.

65. The method according to claim 8, wherein said bio-oil has a HHV of 42 MJ/kg.

66. The method according to claim 8, wherein said bio-oil has a viscosity of less than 20 cP, 60° C.

67. The method according to claim 8, wherein said bio-oil has a viscosity of about 4 to about 12 cP, 60° C.

68. The method according to claim 8, wherein said bio-oil has a viscosity of less than about 50 cP, 40° C.

69. The method according to claim 8, wherein said bio-oil has a viscosity of about 8 to about 42 cP, 40° C.

70. The method according to claim 1, wherein said feedstock is guayule leaves.

71. The method according to claim 70, wherein said bio-oil has oxygen content of less than about 23%.

72. The method according to claim 70, wherein said bio-oil has C/O ratio of more than about 3.8.

73. The method according to claim 70, wherein said bio-oil has H/C ratio of more than about 1.1.

74. The method according to claim 70, wherein said bio-oil has TAN of less than about 29.

75. The method according to claim 70, wherein said bio-oil has a concentration of benzene, toluene, ethyl benzene, p-xylene, and o-xylene of more than about 0.8%.

74. The method according to claim 70, wherein said bio-oil has a concentration of alkyl phenols of more than about 2.7%.

74. The method according to claim 70, wherein said bio-oil has HHV of more than 27 MJ/kg.

74. The method according to claim 70, wherein said bio-oil has a viscosity of less than about 25 cP, 60° C.

75. The method according to claim 70, wherein said bio-oil has a viscosity of about 15 cP, 60° C.

76. The method according to claim 70, wherein said bio-oil has a viscosity of less than about 70 cP, 40° C.

76. The method according to claim 70, wherein said bio-oil has a viscosity of about 56 cP, 40° C.

77. The method according to claim 1, further comprising
(a) first distilling said bio-oil to produce distillates and then reacting said distillates in a hydrodeoxygenation reactor in a chemically reductive atmosphere [hydrogen environment] to produce hydrocarbons, water, and non-condensable gases or
(b) reacting said bio-oil after centrifugation in a hydrodeoxygenation reactor in a chemically reductive atmosphere (e.g., hydrogen environment to produce hydrocarbons, water and non-condensable gases, and then distilling to produce distilled water and distilled hydrocarbons.

78. The method according to claim 77, wherein said method utilizes liquid hourly space velocities of at least about 0.4 l/hr.

79. The method according to claim 77, wherein said process utilizes liquid hourly space velocities of at least about 0.45 l/hr.

80. The method according to claim 77, wherein said reactor utilizes a temperature of about 320° to about 380° C.

81. The method according to claim 77, wherein said reactor utilizes a temperature of about 350° C.

82. The method according to claim 77, wherein said reactor utilizes non-sulfided catalysts.

83. The method according to claim 77, wherein said reactor utilizes ruthenium, platinum, or palladium catalysts on carbon supports.

84. The method according to claim 77, wherein said reactor utilizes ruthenium catalysts on carbon supports.

85. The method according to claim 77, wherein said process utilizes an oil flow rate of about 0.4 to about 0.7 cc oil/cc-catalyst/hr.

86. The method according to claim 77, wherein said process utilizes an oil flow rate of about 0.4 to about 0.7 hr⁻¹.

87. The method according to claim 77, wherein said process utilizes an oil flow rate of more than about 0.4 hr⁻¹.

88. The method according to claim 77, wherein said process utilizes a reactor pressure of about 1600 to about 1800 psi.

89. The method according to claim 77, wherein said process utilizes a hydrogen flow rate of about 3000 sccm.

90. The method according to claim 77, wherein said process utilizes one reactor.

91. The method according to claim 77, wherein said feedstock is guayule bagasse.

92. The method according to claim 77, wherein said process produces distilled hydrocarbons having HHV of more than 40 JM/kg.

93. The method according to claim 77, wherein said process produces distilled hydrocarbons having HHV of about 45 JM/kg.

94. The method according to claim 77, wherein said process produces distilled hydrocarbons having density of about 0.8 g/mL.

95. The method according to claim 77, wherein said distilled hydrocarbons have O/C ratio of less than about 0.1.

96. The method according to claim 77, wherein said distilled hydrocarbons have O/C ratio of less than about 0.01.

97. The method according to claim 77, wherein said distilled hydrocarbons have O/C ratio of less than about 0.001.

98. The method according to claim 77, wherein said distilled hydrocarbons have O/C ratio of about 0.0001.

99. The method according to claim 77, wherein said distilled hydrocarbons have H/C ratio of greater than about 1.5.

100. The method according to claim 77, wherein said distilled hydrocarbons have H/C ratio of greater than about 1.6.

101. The method according to claim 77, wherein said distilled hydrocarbons have H/C ratio of greater than about 1.65.

102. The method according to claim 77, wherein said distilled hydrocarbons have H/C ratio of about 1.92.

103. The method according to claim 77, wherein said distilled hydrocarbons have TAN of less than about 20.

104. The method according to claim 77, wherein said distilled hydrocarbons have TAN of less than about 15.

105. The method according to claim 77, wherein said distilled hydrocarbons have TAN of about 1.

106. The method according to claim 77, wherein said distilled hydrocarbons have density of less than about 9 g/mL.

107. The method according to claim 77, wherein said distilled hydrocarbons have density of less than about 8.6 g/mL.

108. The method according to claim 77, wherein said distilled hydrocarbons have KF of less than about 0.5%.

109. The method according to claim 77, wherein said distilled hydrocarbons have KF of less than about 0.45%.

110. The method according to claim 77, wherein said feedstock is guayule leaves.

111. A bio-oil produced by the method according to claim 1.

112. A HDO bio-oil produced by the method according to claim 77.
